(19) United States
(12) Patent Application Publication
(10) Pub. No.: US 2008/0116669 A1
(43) Pub. Date: May 22, 2008

(54) Knee-protecting airbag device

(75) Inventors: Yuichi Adachi, Aichi-ken (JP); Kazuaki Bito, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/979,752

(22) Filed: Nov. 8, 2007

(30) Foreign Application Priority Data
Nov. 14, 2006 (JP) 2006-308025
Dec. 28, 2006 (JP) 2006-355514
Mar. 14, 2007 (JP) 2007-065401

(51) Int. Cl. B60R 21/203

(52) U.S. Cl. 280/730.1; 280/731

(57) ABSTRACT

A knee-protecting airbag device is configured so that a folded airbag is accommodated and held in an accommodation part at the side of a lower portion in a column cover. An outer peripheral wall at completion of inflation of the airbag includes a driver-side wall portion and a column-sidewall portion. At the completion of inflation of the airbag, the column-side wall portion covers a bottom surface of a periphery of the accommodation part of the column cover, and areas of a panel surface, which are located at both left and right sides of the column cover from below the column cover. A front-side portion and a rear-side portion of the column-side wall portion are set so that at the completion of inflation of the single airbag, the intersection angle between a front surface of the front-side part and a front surface of the rear-side part is substantially equal to the intersection angle between the panel surface and a bottom surface of the column cover protruded from the panel surface.

### BACKGROUND OF THE INVENTION

1. Field of the Invention

The present invention relates to a knee-protecting airbag device which protects knees of a driver by an airbag inflated at a vehicle collision. More particularly, the present invention relates to a knee-protecting airbag device to be attached to a steering column so that a folded airbag is accommodated in a column cover disposed to cover the steering column and to project backwardly from an instrument panel.

2. Related Art

Hitherto, knee-protecting airbag devices have been configured so that a folded airbag is accommodated in a lower part of a column cover, and that when the device is operated, inflation gas is supplied to the airbag which is then projected from the column cover so as to be disposed in front of the knees of a driver while expanding and inflating (see, for example, JP-A-2002-37003).

In a conventional knee-protecting airbag device, an inflator provided in an airbag discharges inflation gas both leftwardly and rightwardly obliquely downwardly when the device is operated. Then, the airbag expands and inflates radially from substantially the center of the column cover. Thus, both knees of a driver are unfolded by the expanding airbag to thereby protect the knees of the driver from the column cover.

However, in the case of protecting knees of a driver, it is desirable to protect the knees not only from a column cover but from instrument panels provided on both the left and right sides of the column cover. But, because of the facts that the column cover itself protrudes from the instrument panels, and that an airbag protrudes from the bottom surface side of a protruding part of the column cover, the airbag is liable to complete inflation thereof so as to be detached backwardly from and float with respect to the rear surface of each of the instrument panels.

Thus, even when the knee being forwardly moving abuts against a part of the airbag, which is spaced apart backwardly from the rear surface of the instrument panel, this part is not supported by the instrument panels. Thus, in a case where this part is not pushed until this part abuts against the instrument panels, this part is not supported. Consequently, no reaction force can be assured. Because the airbag is spaced apart from the instrument panels, the airbag cannot ensure a cushioning action. Also, the knees cannot quickly be caught by the airbag.

### SUMMARY OF THE INVENTION

The invention is accomplished to solve the aforementioned problems. An object of the invention is to provide a knee-protecting airbag device configured so that an airbag at completion of inflation thereof can smoothly be brought into close contact with an instrument panel and can quickly ensure a cushioning action and catch knees.

According to the invention, there is provided a knee-protecting airbag device mounted in a lower portion side of a column cover which covers a steering column and protrudes obliquely upwardly and backwardly from an instrument panel so that a folded airbag is accommodated and mounted in an accommodation part in the lower portion side of the column cover, that when operated, inflation gas is supplied to the airbag which is then protruded obliquely backwardly and downwardly from the accommodation part in the lower portion side of the column cover while expanding and inflating, so as to be disposed to cover a bottom surface of a periphery of the accommodation part of the column cover and a rear surface of the instrument panel, which is placed in a periphery of the column cover, in front of knees of a driver. This knee-protecting airbag device is featured in the following respects.

That is, a panel surface placed at each of lateral sides of the column cover from below the column cover in the rear surface of the instrument panel covered with the airbag at completion of inflation thereof is provided as a substantially flat surface extending in a lateral direction so that an upper portion thereof protrudes backwardly.

The column cover is provided as a substantially flat surface so that a vicinity of a front end of a projection opening of the airbag at the completion of inflation thereof in the accommodation part is detached backwardly from the panel surface, and that the bottom surface is extended obliquely upwardly and backwardly, as viewed from a side, to approach closer to a horizontal plane from the panel surface so as to intersect with the panel surface at an angle.

An outer peripheral wall of the airbag at completion of inflation thereof includes a driver-side wall portion disposed at a driver side and a column side wall portion configured so that a mounting part thereof to be mounted in the accommodation part is disposed in proximity of a center in anteroposterior and lateral directions, and that the entirety of an outer peripheral edge thereof continues to an outer peripheral edge of the driver-side wall portion.

The column-side wall portion of the airbag is configured to cover, at completion of inflation of the airbag, the bottom surface of the periphery of the accommodation part of the column cover and the panel surface which is placed at each of the lateral sides of the column cover from below the column cover.

The airbag is configured so that at completion of inflation of the single airbag, an intersection angle between front surfaces of a front-side part and a rear-side part placed in anteroposterior positions in a vicinity of a center in an anteroposterior direction of the column-side wall portion is substantially equal to an intersection angle between the panel surface and a bottom surface of the column cover protruding from the panel surface.

In the knee-protecting airbag device according to the invention, the airbag is disposed so that in a case where inflation gas is supplied to the airbag when the airbag device is operated, the airbag is protruded obliquely backwardly and downwardly from the accommodation part in the lower portion side of the column cover while expanding and inflating, and that thus, the airbag covers a bottom surface of a periphery of the accommodation part of the column cover and a rear surface of the instrument panel, which is placed in a periphery of the column cover, in front of knees of a driver. At that time, the vicinity of a mounting part disposed in proximity of the center in anteroposterior and lateral directions of the column-sidewall portion of the airbag enters the accommodation part of the column cover. However, the vicinity of the periphery of the accommodation part, which is detached from the projection opening of the accommodation part, for example, the rear-side part of the column-side wall portion, which is placed in rear of the accommodation part, is closely attached to the bottom surface of the column cover. The front-side part of the column-side wall portion is disposed so that when the rear-side part of the column-side wall portion is closely attached to the backward-side bottom surface of the periphery of the projection opening of the accommodation part of the column cover, the intersection angle between the front surface of the front-side part of the column-side wall portion and the front surface of the rear-side part is substantially equal to the intersection angle between the panel surface and the bottom surface of the column cover protruding from the panel surface at the completion of inflation of the single airbag. Thus, the front-side part of the column-sidewall portion is configured so that a portion of the accommodation part, which is detached from the projection opening, can easily and closely be attached to the panel surface placed at each of both lateral sides of the column cover. That is, a front-side central part in the vicinity of the center in the lateral direction of the front-side part of the column-side wall portion, and front-side left and right parts placed at both lateral sides of the front-side part of the column-side wall portion, which are respectively placed at both lateral sides of the column cover, are closely attached to the panel surface placed at each of both lateral sides of the column cover from below the column cover.

Consequently, the front-side part and the rear-side part of the column-side wall portion of the airbag can be closely attached to the panel surface and the bottom surface of the column cover, without floating so as to be detached therefrom, to thereby enhance support of the airbag. Even when the knees of a driver, which move frontwardly or obliquely frontwardly upwardly, are caught by the driver-side wall portion which is a part in rear of the front-side part and the rear-side part in the airbag, the airbag is quickly supported by the panel surface and the bottom surface of the column cover. Thus, the airbag can smoothly ensure cushioning ability and catch the knees.

Accordingly, the knee-protecting airbag device according to the invention is configured so that the airbag is smoothly and closely attached to the rear surface of the instrument panel and to the bottom surface of the column cover at completion of inflation thereof. Consequently, the knee-protecting airbag device can quickly ensure a cushioning action and catch the knees of a driver.

Additionally, in such an airbag, the front-side part and the rear-side part of the column-side wall portion are not bent by surrounding-members. The airbag ensures a bent shape as a shape thereof at the completion of inflation thereof. Because no unnecessary pressing force is applied to the outer peripheral wall of the airbag at the completion of inflation thereof, damages due to interference with the surrounding-members, which may cause gas leakage, are hard to occur.

Also, it is desirable that the intersection angle between the front surfaces of the front-side part and the rear-side part of the column-side wall portion of the airbag is set by the front tether and the rear tether, which are provided in the airbag and respectively extend from the front-side part and the rear-side part to determine the thickness of the airbag at the completion of inflation of the airbag by being connected to the driver-side wall portion.

That is, in the case of employing such a configuration, when an airbag is manufactured by sewing and gluing foundation cloths for the airbag, it is sufficient to simply connect the front tether and the rear tether to the driver-side wall portion and the column-side wall portion, without three-dimensionally performing a connecting operation, such as sewing. Consequently, an airbag can easily be manufactured, as compared with the case of three-dimensionally cutting a foundation cloth for an airbag and setting the intersection angle between the front-side part and the rear-side part of the column-side wall portion.

In this case, it is advisable to constitute the airbag as a flat type airbag in which the driver-side wall portion and the column-side wall portion have the substantially same outer shape, and to provide the front tether and the rear tether so that the span between connection parts of the front tether and the rear tether, which are connected to the driver-side wall portion, is set to be shorter than the span between connection parts of the front tether and the rear tether, which are connected to the column-side wall portion.

That is, in this configuration, both ends of each of two tethers are connected to the column-side wall portion and the driver-side wall portion so that the span between the connection parts of the two tethers placed anterior and posterior to (or above and below) the airbag, which are connected to the driver-side wall portion, is set to be shorter than the span between the connection parts of the front tether and the rear tether, which are connected to the column-side wall portion. Then, the column-side wall portion and the driver-side wall portion are flatly expanded to overlap with each other. Thus, the peripheries of the column-side wall portion and the driver-side wall portion are connected to each other by sewing or the like. Consequently, an airbag can extremely easily be manufactured by a planar connecting operation.

Also, it is desirable that the projection opening, from which the inflated airbag is protruded, is arranged from the bottom surface to the lateral side surfaces of the column cover to extend in both lateral directions of the accommodation part from below the accommodation part.

With such a configuration, the airbag can be protruded from both the lateral side surfaces of the column cover, which approach closer to the panel surface. Thus, the column-side wall portion at the completion of inflation of the airbag can be more closely attached to the lateral side parts of the panel surface, which approach closely to and are in proximity of the column cover.

Another object of the invention is to provide an airbag device enabled to improve the gas seal ability of the periphery of the insertion hole into which an inflator is inserted, and upon which a tensile force acts at expansion/inflation of the airbag.

According to the invention, there is provided an airbag device configured to have an airbag adapted to expand and inflate while protruding from a mounting part, in which the airbag is folded and accommodated, when inflation gas flows thereinto, and an inflator attached to the mounting part by placing one end thereof outside the airbag and inserting the other end having a gas discharge port, which is enabled to discharge inflation gas, into the airbag through an insertion hole. An attaching part of the airbag being attached to the mounting part so that a tensile force acts upon a periphery of the insertion hole, whose position is restricted to the other end of the inflator at expansion/inflation of the airbag. The airbag device is featured in the following respects.

That is, the air bag comprises an airbag body having the insertion hole, and being configured to inflate when the inflation gas is flowed thereinto, to constitute an outer peripheral wall of the airbag, and a flexible seal cloth having a fitting hole, into which the other end of the inflator to be inserted into the insertion hole is fittable, and being placed on a periphery of the insertion hole of the airbag body. The seal cloth is attached to the periphery of the insertion hole of the airbag body in a state in which a looseness enabling relative displacement movement between a periphery of the fitting hole of the seal cloth and the periphery of the insertion hole is provided at a side in a direction of application of the tensile force in the periphery of the fitting hole and in which the other end of the inflator to be inserted into the insertion hole is fit into the fitting hole.

In the airbag device according to the invention, when inflation gas is discharged from the gas discharge port at the other side of the inflator inserted in the airbag during an operation, the airbag protrudes from the mounting part while performing expansion/inflation. Then, the airbag body of the airbag completes the inflation. At that time, the position of the periphery of the insertion hole of the airbag is restricted by the other end of the inflator attached to the mounting part. Thus, a tensile force acts in a direction in which the airbag protrudes from the mounting part of the airbag body. A gap is generated between the part placed in the direction of action of the tensile force on the inner peripheral surface of the insertion hole and the outer peripheral surface of the inflator, which are interposed by the insertion hole.

However, the seal cloth can perform shift movement with respect to the periphery of the insertion hole of the airbag body in a state, in which the inflator is fit into the fitting hole, while eliminating the looseness. Thus, the gap between the outer peripheral surface of the inflator and the inner peripheral surface of the insertion hole can be covered with the seal cloth. Accordingly, inflation gas can be prevented from leaking to the outside of the airbag through the insertion hole. Consequently, the gas sealability of the periphery of the insertion hole of the airbag body can be ensured.

Therefore, the airbag device according to the invention can improve the gas sealability of the insertion hole, into which the inflator is inserted, and upon which a tensile force acts at expansion/inflation of the airbag.

Although the seal cloth for the airbag can be provided on the outer peripheral surface of the airbag body or on the inner peripheral surface thereof, it is preferable that the seal cloth is provided on the inner peripheral surface of the airbag body. That is, in a case where the seal cloth for the airbag is provided on the outer peripheral surface of the airbag body, when inflation gas flows into a space between the airbag body and the seal cloth provided on the outer peripheral surface of the airbag body through the insertion hole of the airbag body, the seal cloth receives a pressure in a direction in which the seal cloth is detached from the airbag body. Thus, the necessity for assuring a looseness enabling the relative shift movement of the seal cloth from the airbag body is caused. Also, the necessity for attaching the entire outer periphery of the seal cloth to the airbag body by sewing, in consideration of mounting-strength, is caused. On the other hand, in a case where the seal cloth is provided on the inner peripheral surface of the airbag body, the seal cloth is pushed against the airbag body at inflation of the airbag body. Thus, as compared with the case of providing the seal cloth on the outer peripheral surface of the airbag body, the mounting strength can be reduced. Consequently, the seal cloth can easily be attached to the airbag body.

Further, in the case where the seal cloth is provided on the inner peripheral surface of the airbag body, only both edges extending along a direction of application of a tensile force generated on the periphery of the insertion hole at the inflation, which are intervened by the fitting hole, can be attached to the airbag body. That is, in a case where both edges extending along the direction of action of the tensile force on the seal cloth are attached to the airbag body, the seal cloth eliminates the looseness at the inflation of the airbag body. Thus, when the seal cloth covers the gap between the outer peripheral surface of the inflator and the inner peripheral surface of the insertion hole, both of a part at the side of a starting point of the shift movement of the seal cloth, that is, the side opposite to the direction of action of the tensile force on the periphery of the insertion hole, and a part at the side of a destination of the shift movement of the seal cloth, that is, the side in the direction of the tensile force on the periphery of the insertion hole can stably be attached to the airbag body. Accordingly, at the inflation of the airbag body, the seal cloth smoothly performs shift movement without being convoluted into the periphery of the insertion hole, upon which the tensile force is applied. On the other hand, both edges in a direction perpendicular to the direction of action of the tensile force on the periphery of the insertion hole in the seal cloth are shifted and are apart from the insertion hole. Thus, the seal cloth does not perform the shift movement so as to pass through the insertion hole. Additionally, the seal cloth is placed on the inner peripheral surface of the airbag body. At the inflation of the airbag body, a pressing force associated with the pressure due to the inflation gas acts on the seal cloth. Thus, in a case where the seal cloth is not so close as to enter the insertion hole, the seal cloth is difficult to be convoluted. Consequently, in a case where the seal cloth is provided on the inner peripheral surface of the airbag body, the gas sealability can be obtained even when only both edges extending along the direction of action of the tensile force on the periphery of the insertion hole of the airbag body, which are intervened by the fitting hole, are attached to the airbag body. Accordingly, an operation of attaching the seal cloth to the airbag body is facilitated.

Incidentally, the attachment of the seal cloth to the airbag body can be achieved not only by utilizing sewing and bonding, but also by fastening the seal cloth, which is other than the edge in the direction of action of the tensile force in the periphery of the insertion hole at the side of the destination of the shift movement, together with components of the airbag device, such as the inflator, to the mounting part when the components of the airbag device are attached to the mounting part.

Another object of the invention is to provide a knee-protecting airbag device enabled to assure a cushioning function by completing, even when the airbag is contacted with left and right knees of an occupant in an initial stage of expansion/inflation thereof, expansion toward both left and right sides without unfolding both the left and right knees of the occupant, and to smoothly catch both left and right knees of the occupant, which move frontwardly.

According to the invention, there is provided a knee-protecting airbag device having an airbag placed in front of left and right knees of a seated occupant at completion of expansion/inflation by being supplied with inflation gas at completion of inflation by being supplied with inflation gas. The airbag is folded by bringing both lateral edges thereof at completion of inflation thereof close to the center thereof so as to set a lateral width dimension to be less than a width dimension thereof at the completion of inflation thereof. The airbag is accommodated in a mounting part placed in an area in front of a space between both left and right knees of the occupant. The airbag device is featured in the following respects. That is, the airbag comprises an airbag body which is inflated like a plate and which has an occupant side wall portion placed at an occupant-side at completion of inflation, and a vehicle-body side wall portion placed at a vehicle-body-side wall portion, and a slip cloth which has flexibility and is placed at an occupant-side of the airbag body at expansion/inflation, the slip cloth is configured so that a front surface of the slip cloth is made to abut against the left and right knees of the occupant at an occupant side of the airbag body protruding from the accommodation part so as to close a space between both the knees by the front surface, that the airbag body is slid on a rear surface of the slip cloth so as to be able to guide the expansion of the airbag body in both lateral directions, the slip close is such that a loosened portion folded only with the slip cloth is provided therein so as to shorten a lateral length thereof, and that the slip cloth is accommodated together with the airbag body in the accommodation part so as to cover at least both lateral side surfaces from an occupant side surface of the folded airbag body. A lateral length dimension of the slip cloth expanded flat is set at a dimension enabling the front surface to abut against the left and right knees of the occupant at the occupant side of the airbag body which projects from the accommodation part at expansion/inflation of the airbag, so as to close the space between the left and right knees of the occupant.

In the knee-protecting airbag device according to the invention, when operated, the airbag body of the airbag is supplied with inflation gas and protrudes from the accommodation part. At that time, even in a case the airbag body enters a space between the left and right knees where while being contacted with the left and right knees of an occupant before the airbag body expands to both lateral sides, the slip cloth covers at least both the left and right side surfaces from the occupant side surface of the folded airbag body when folding and accommodating the airbag body. Thus, while quickly drawing out the loosened portion, the front surface of the occupant side of the airbag body is made to abut against the left and right knees of the occupant so as to close the space between the left and right knees. Then, the airbag body is slid on the rear surface of the slip cloth to guide the expansion in the lateral direction of the airbag body. Accordingly, the airbag body expands and inflates to the lateral sides so as to face both the left and right knees without entering the space between both the left and right knees of the occupant.

Therefore, in the knee-protecting airbag device according to the invention, even in a case where the airbag is in contact with both the left and right knees of the occupant in an initial stage of the expansion/inflation, the slip cloth closes the space between both the left and right knees while being contacted with both the left and right knees. Consequently, the airbag body completes the expansion thereof to both the lateral sides thereof. Thus, the airbag body can assure the cushioning action and can catch both the left and right knees which smoothly and frontwardly move.

Incidentally, in a case where the space between both the left and right knees of an occupant can be closed by applying the front-surface side of the slip cloth to the left and right knees of the occupant at the occupant-side of the airbag body protruding from the accommodation part at expansion/inflation of the airbag, the lateral length dimension of the slip cloth expanded flat can be equal to or more than a lateral width dimension sufficient to cover at least both the left and right knees of the seated occupant from front. It is sufficient that the lateral length dimension of the slip cloth expanded flat is equal to or more than a dimension equivalent to a lateral length dimension of the airbag body expanded flat, which includes a dimension that is slightly shorter than this lateral length dimension. That is, the airbag body itself is set to assure a lateral dimension, at which both the left and right knees of an occupant can be protected in a state in which the expansion/inflation thereof is completed. The lateral length dimension of the airbag body expanded flat in a non-inflation state is longer than the lateral length dimension thereof at inflation. Additionally, in a case where the lateral length dimension of the slip cloth expanded flat is set to be equal to or longer than the lateral length dimension of the airbag body expanded flat, the slip cloth can ensure a state in which the airbag at expansion/inflation is made to surely abut against both the left and right knees of an occupant.

In a state in which the occupant-side wall portion of the airbag body is overlapped with both of associated lateral edges of the slip cloth, a convolution part is formed. Preferably, the convolution part, into which only a part of both the lateral edges of the slip cloth is convoluted, is formed in a folding portion in which the slip cloth is folded to be close to the center in the lateral direction of both the lateral edges of the airbag body. Then, the convolution part is accommodated together with the airbag body in the accommodation part.

With such a configuration, both the lateral edges of the slip cloth are held in the folding portion of the airbag body, utilizing the convolution part. In an initial stage of inflation of the airbag body, a contact part of the slip cloth, which is contacted with both the left and right knees of an occupant, can stabilize a movement locus. The contact part can appropriately be contacted with both the knees of the occupant and also can be supported by both the left and right knees. Thus, the airbag body can surely be expanded and guided on the rear surface side of the slip cloth. Additionally, the slip cloth is provided with a looseness part so as to only convolute the convolution part, which is provided at each of both lateral sides of the slip cloth, into the folding portion of the airbag body. Thus, relative movement at expansion in a lateral direction of the airbag body is performed by causing the airbag body to slip on the rear side surface of the slip cloth and can freely be achieved for a margin of a length of the looseness part without being regulated.

Further, in a case where the airbag body can be guided by the slip cloth during the expansion of the airbag body, the slip cloth becomes unnecessary upon completion of inflation of the airbag body. Thus, the slip cloth is not necessarily connected to the airbag body. Incidentally, in a case where a central part in the lateral direction of the slip cloth is connected to a central part in the lateral direction of the occupant-side wall portion of the airbag body, or where the slip cloth is connected to a part of the airbag body by connecting at least one of the lateral edges of the slip cloth to an associated one of the lateral edges of the airbag body, there is no fear that the slip cloth is detached from the occupant-side wall portion of the airbag body in the course of expansion of the airbag body. Consequently, more stable lateral expansion of the airbag body can be assured. Additionally, fibers of the slip cloth can be prevented from flying apart to an occupant.

Further, in a case where the central part in the lateral direction of the slip cloth is connected to the central part in the lateral direction of the occupant-sidewall portion of the airbag body, because both lateral edges of the slip cloth are not connected to the airbag body, when folding of the vicinity of each of both the lateral edges of the airbag body is unfolded, lateral expansion of the airbag body can quickly be performed in a balanced manner without resistance due to the slip cloth. On the other hand, in a case where at least one of the lateral edges of the slip cloth is connected to an associated one of the lateral edges of the airbag, resistance is given by the slip cloth in the proximity of the edge connected to the slip cloth at the expansion. However, the slip cloth can surely be placed on the occupant-side portion of the airbag body until the completion of the expansion. The airbag body can smoothly be expanded and guided over the entire region extending from the rear-surface side of the slip cloth to the lateral edges connected thereto.

Additionally, preferably, the knee-protecting airbag device according to the invention is configured as a knee-protecting airbag device to be attached to a steering column, which is mounted in the bottom portion of the column cover covering the steering column protruding backwardly from the instrument panel so that when operated, an accommodated airbag is downwardly protruded from the accommodation part and is inflated by being expanded to both lateral sides.

That is, in the airbag device to be attached to the steering column, the distance between the accommodation part in the column cover and each of the left and right knees of a driver acting as an occupant is short. Although the probability of causing the airbag, which performs expansion/inflation, to enter a space between both the knees of the driver is increased, the airbag body enabled to protect the knees can stably be expanded and inflated in both the lateral directions, without permitting the airbag body to enter a space between both the left and right knees, in the knee-protecting airbag device according to the invention. Consequently, the airbag device can preferably be used.

In this case, the inflator for supplying inflation gas is accommodated in the airbag body. Also, the airbag can be accommodated in the accommodation part by adjacently providing at least a part of the folding portions for folding the cloth close to the center in the lateral direction of both lateral edge sides of the airbag body at the expansion/inflation so as to be provided side by side in the lateral direction below the inflator.

With such a configuration, the lateral width dimension of the folded airbag and the inflator can be reduced. Thus, the airbag device according to the invention can be more desirably used as a knee-protecting airbag device with a steering column, which is limited in mounting-space.

### BRIEF DESCRIPTION OF THE DRAWINGS

FIG. 1 is a schematic side view illustrating the vicinity of a column cover in which a knee-protecting airbag device according to a first embodiment of the invention is mounted.

FIG. 2 is a schematically enlarged longitudinally cross-sectional view taken along an anteroposterior direction of the vicinity of the column cover in which the knee-protecting airbag device according to the first embodiment of the invention is mounted.

FIG. 3 is a schematically enlarged transversally cross-sectional view taken on line III-III in FIG. 2 illustrating the vicinity of the column cover in which the knee-protecting airbag device according to the first embodiment of the invention is mounted.

FIG. 4 is a schematically enlarged transversally cross-sectional view taken on line IV-IV in FIG. 2 along a lateral direction illustrating the vicinity of the column cover in which the knee-protecting airbag device according to the first embodiment of the invention is mounted.

FIG. 5 is a perspective view illustrating a state before a door portion of the column cover used for the knee-protecting airbag device according to the first embodiment of the invention is opened, and a state in which the door portion is opened.

FIG. 6 is a plan view illustrating a state in which an airbag used in the knee-protecting airbag device according to the first embodiment of the invention is flatly expanded.

FIG. 7 is a plan view illustrating the airbag which is to be used in the first embodiment and which has a column side wall portion schematically partitioned into front-side and rear-side portions.

FIG. 8 is a cross-sectional view taken on line VIII-VIII shown in FIG. 6, illustrating the airbag which is to be used in the knee-protecting airbag device according to the first embodiment and is just before completion of inflation thereof when being singly inflated.

FIG. 9 is a cross-sectional view illustrating the airbag, which is to be used in the knee-protecting airbag device according to first the embodiment, at completion of inflation thereof when being singly inflated.

FIG. 10 is a schematically enlarged longitudinal cross-sectional view illustrating the knee-protecting airbag device according to the first embodiment during operation.

FIG. 11 is a schematically enlarged longitudinal cross-sectional view taken along a substantially lateral direction, illustrating the knee-protecting airbag device according to the first embodiment during operation.

FIG. 12 is a schematically enlarged transversally cross-sectional view illustrating the vicinity of the column cover in which the knee-protecting airbag device according to the second embodiment is mounted.

FIG. 13 is a perspective view illustrating a case, an inflator, and a diffuser for use in the airbag device according to the second embodiment.

FIG. 14 is a front view illustrating an airbag for use in the airbag device according to the second embodiment.

FIG. 15 is a schematically enlarged longitudinally cross-sectional view taken on line XV-XV in FIG. 14 illustrating an assembling state in which the airbag for use in the airbag device according to the first embodiment is assembled to the inflator.

FIGS. 16A to 16D are views illustrating a process of folding the airbag for use in the airbag device according to the second embodiment.

FIG. 17 is a schematically longitudinally cross-sectional view illustrating a vicinity of a lower panel in which an airbag device according to a third embodiment is mounted.

FIG. 18 is an enlarged schematically longitudinally cross-sectional view illustrating the airbag device according to the third embodiment.

FIG. 19 is a rear view illustrating a state in which an airbag, which is to be used in the airbag device according to the third embodiment and is singly inflated.

FIG. 20 is a cross-sectional view taken on line XX-XX shown in FIG. 19, illustrating the airbag to be used in the airbag device according to the third embodiment in a state in which the airbag is singly inflated.

FIG. 21 is a schematically transversally cross-sectional view illustrating the airbag device according to the third embodiment during an operation.

FIG. 22 is a perspective view illustrating a vicinity of an insertion hole, into which an inflator is inserted, in an airbag for use in an airbag device according to the fourth embodiment.

FIGS. 23A and 23B are schematically partially transversally cross-sectional view illustrating an operation of the airbag device according to the fourth embodiment.

FIG. 24 is a plan view illustrating an airbag for use in the knee-protecting airbag device according to the fifth embodiment, and also illustrating constituent materials of the airbag.

FIGS. 25A to 25E are views illustrating a process of folding the airbag for use in the airbag device according to the fifth embodiment.

FIGS. 26A and 26B are side views respectively illustrating steps of an operation of the knee-protecting airbag device according to the fifth embodiment in sequence.

FIGS. 27A and 27B are side views respectively illustrating steps of an operation of the knee-protecting airbag device according to the fifth embodiment in sequence, which are performed after the operation illustrated in FIGS. 26A and 26B.

FIG. 28 is a schematically enlarged longitudinally cross-sectional view taken along a lateral direction of the vicinity of the column cover in which a knee-protecting airbag device according to the sixth embodiment is mounted.

FIGS. 29A and 29B are side views respectively illustrating steps of an operation of the knee-protecting airbag device according to the sixth embodiment in sequence.

FIGS. 30A and 30B are side views respectively illustrating steps of an operation of the knee-protecting airbag device according to the sixth embodiment in sequence, which are performed after the operation illustrated in FIGS. 29A and 29B.

FIG. 31 is a schematically enlarged longitudinally cross-sectional view taken along a lateral direction of the vicinity of the column cover in which a knee-protecting airbag device according to the seventh embodiment is mounted.

FIGS. 32A and 32B are side views respectively illustrating steps of an operation of the knee-protecting airbag device according to the seventh embodiment in sequence.

FIGS. 33A and 33B are side views respectively illustrating steps of an operation of the knee-protecting airbag device according to the seventh embodiment in sequence, which are performed after the operation illustrated in FIGS. 32A and 32B.

### DETAILED DESCRIPTION OF THE PREFERRED EMBODIMENTS

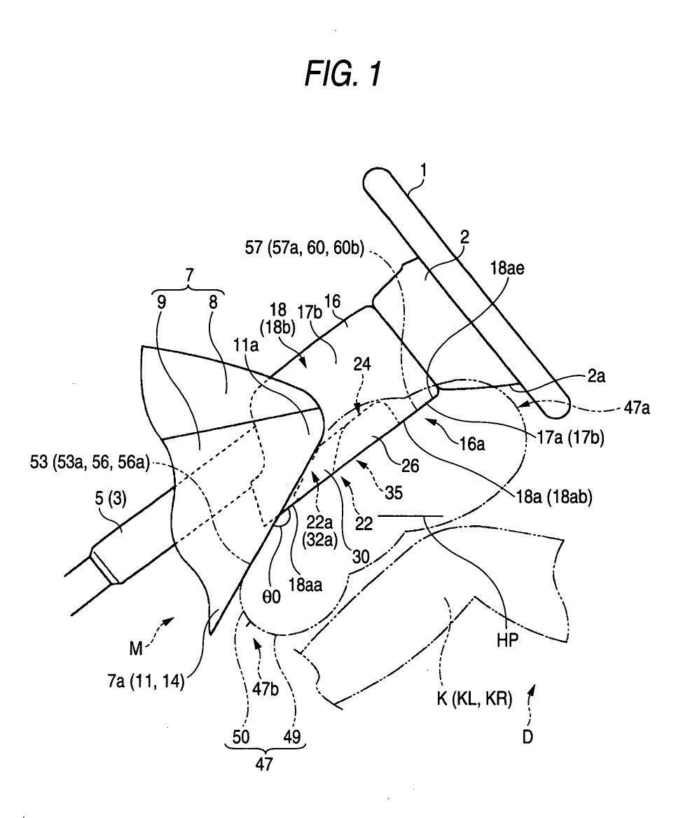

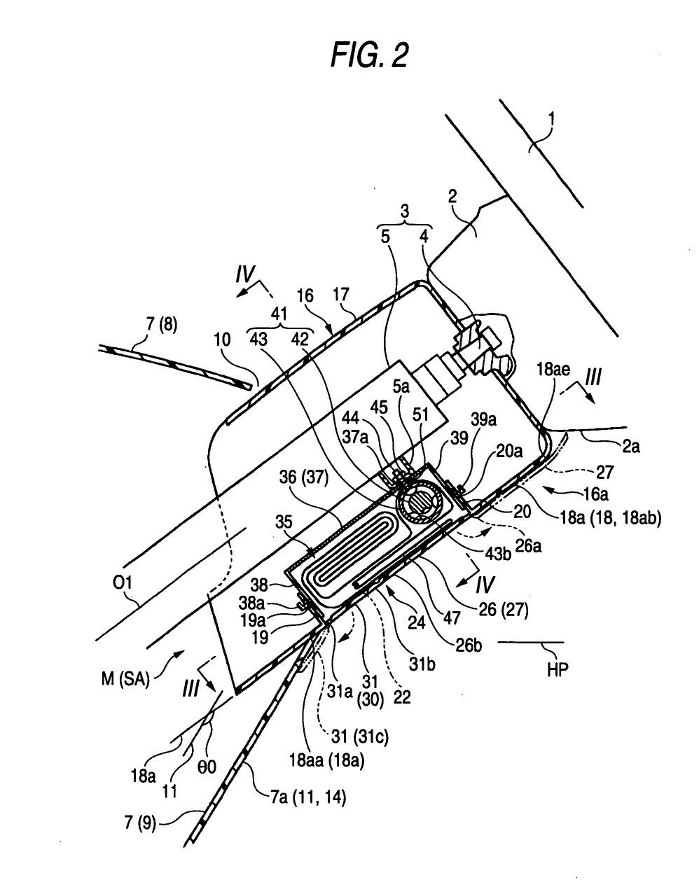

Hereinafter, a first embodiment of the invention is described with reference to the accompanying drawings. As illustrated in FIGS. 2 to 4, the knee-protecting airbag device M is configured so that a folded airbag 47 is accommodated in a lower portion 16a of the column cover 16. The column cover 16 covers a steering column 3 and protrudes obliquely upwardly and rearwardly from an instrument panel 7 (see FIGS. 1 and 2). Also, as illustrated in FIGS. 2 to 4, the knee-protecting airbag device M is configured to have the folded airbag 47, an inflator 41 for supplying inflation gas to the airbag 47, and a case 36 constituting an accommodation part 35 which accommodates the airbag 47 and the inflator 41. The inflated airbag 47 push-opens a door portion 26 provided in the column cover 16 and is disposed in front of both knees K (KL, KR) of a seated driver D (see FIGS. 1, 10, and 11).

Incidentally, in the present specification, unless otherwise noted, anteroposterior directions, lateral directions, and upward and downward directions respectively coincide with those of a vehicle which is in steering-ahead steering.

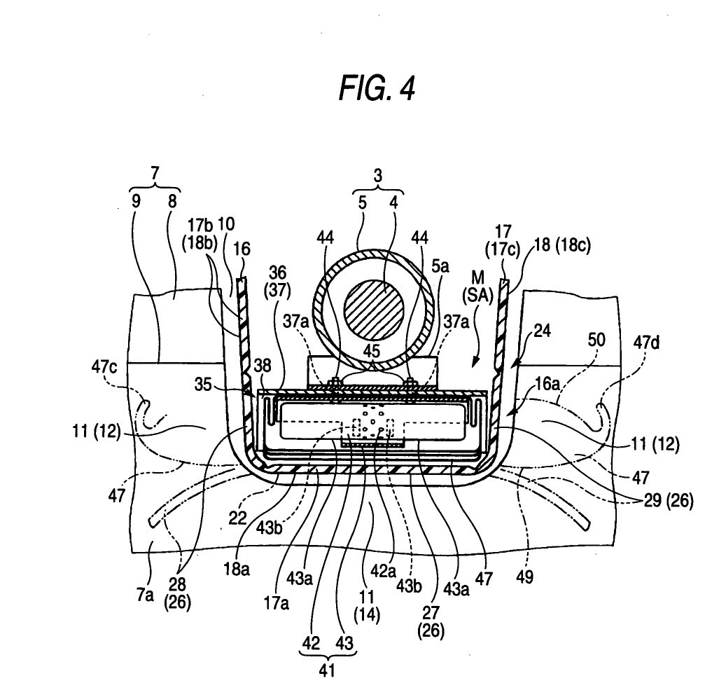

As illustrated in FIGS. 1 and 4, the instrument panel has a topside upper panel 8 and a downside lower panel 9. A part of the instrument panel 7, from which the column cover 16 is projected, is constituted as a vicinity of a boundary part between the upper panel 8 and the lower panel 9. An accommodation opening 10, from which the column cover 16 is protruded, is provided in this part of the instrument panel 7. The airbag 47 having completed inflation covers the periphery of the accommodation opening 10 of a rear surface 7a of the instrument panel 7, more particularly, the periphery of the accommodation opening 10 in the lower panel 9. A panel surface 11 of the lower panel 9, which is covered with the airbag 47 at the completion of inflation, is constituted by including a left area 12 and a right area 13 respectively provided on the left and right sides of the column cover 16, and a lower area 14 provided below the column cover 16 (see FIG. 4). Then, the panel surface 11 is provided as an inclined surface in an overhanging state in which an upper part 11a backwardly overhangs, and also as a substantially flat surface extending in a lateral direction.

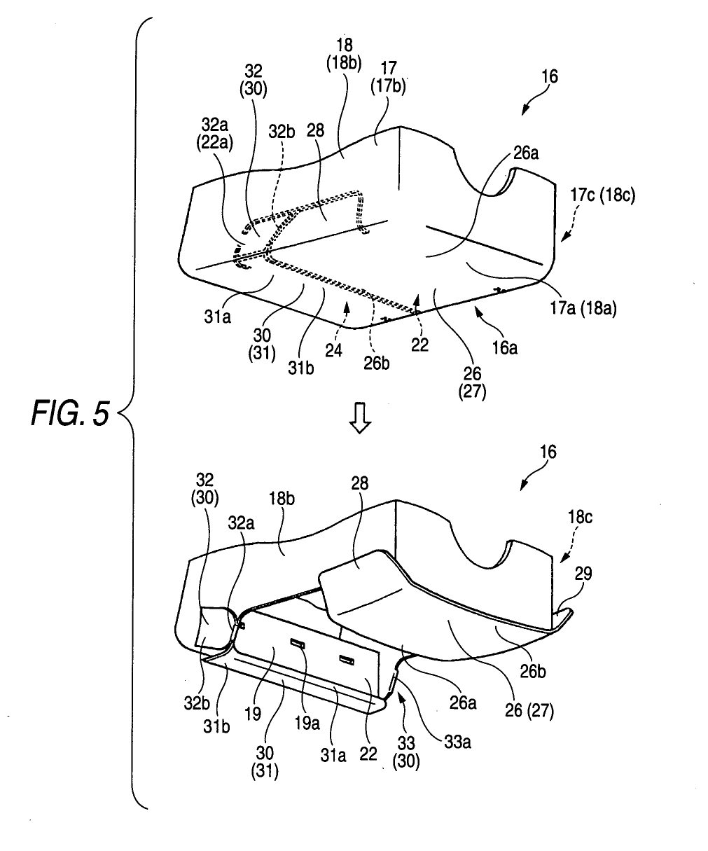

As illustrated in FIGS. 1 to 4, the column cover 16 is shaped into a substantially quadrangularly cylinder, and is made of a synthetic resin. The column cover 16 is attached to a column tube 5 of the steering column 3 at a part (not shown) thereof, and protrudes backwardly from the accommodation opening 10 of the instrument panel 7. Additionally, the column cover 16 is inclined and provided in front of the seated driver D so that a front end of the column cover 16 is downwardly arranged along an axial direction O1 (see FIG. 2), and that a rear end thereof is upwardly placed. Incidentally, the steering column 3 is configured to have a main shaft 4 and the column tube 5 disposed therearound. A steering wheel 1 is connected to the main shaft 4 (see FIG. 2). Also, the column cover 16 is provided so that a vicinity of a front end 22a (see FIG. 1) of the projection opening 22, from which the airbag 47 protrudes at expansion/inflation thereof, in the accommodation part 35 is set to be a position from which the column cover 16 is detached from the panel surface 11, and that the bottom surface 18a viewed from a side is provided as a substantially flat surface which intersects with the panel surface 11 at an intersection angle θ0 by causing a rear end side 18ae to approach close to a horizontal plane HP from the panel surface 11 while being extended upwardly and backwardly from a front-side bottom surface side 18a. In the first embodiment, the bottom surface 18a of the column cover 16 is provided along the axial direction O1 of the steering column 3. Further, in the first embodiment, the front end 22a of the projection opening 22 of the accommodation part 35 is a part at which each of hinge portions 32a and 33a of an auxiliary left door portion 32 and an auxiliary right door portion 33 is provided (see FIG. 5).

As illustrated in FIGS. 5, 10, and 11, a door portion 26 to be opened by being pressed by the airbag 47, is provided in the column cover 16 so that the single projection opening 22, from which the airbag 47 protrudes, can be formed in an area extending from the bottom surface 18a of an outer peripheral surface 18 to each of the a left-side surface 18b and a right-side surface 18c. The door portion 26 is placed in rear of the panel surface 11 of the instrument panel 7 (see FIG. 1) and has a lower door part 27 placed at the side of the bottom surface 18a of the column cover 16, a left door part 28 placed at the side of the left-side surface 18b of the column cover 16, and a right door part 29 placed at the side of the right-side surface 18c of the column cover 16. A breakably preformed part 24, which can be broken by being pressed by the inflated airbag 47, is formed around the door portion 26. The breakably preformed part 24 is constituted by providing a linearly continuous and concave groove in an inner-peripheral surface of the column cover 16 so as to reduce the thickness of the column cover 16.

Further, the door portion 26 is opened by employing a hinge part 26a, which is constituted by an integral hinge disposed at the rear side of the lower door part 27, as a rotating center at opening thereof, and by backwardly rotating a front edge 26b. At that time, the left door part 28 and the right door part 29 are disposed so that the door parts 28 and 29 are backwardly opened together with the lower door part 27 in a state in which the bottom edges of the door parts 28 and 29 are connected to both the left and right edges of the lower door part 27, respectively, as illustrated in FIG. 5, and that the door parts 28 and 29 swing back so as to be contacted with the left-side surface 18b and the right-side surface 18c of the column cover 16, respectively.

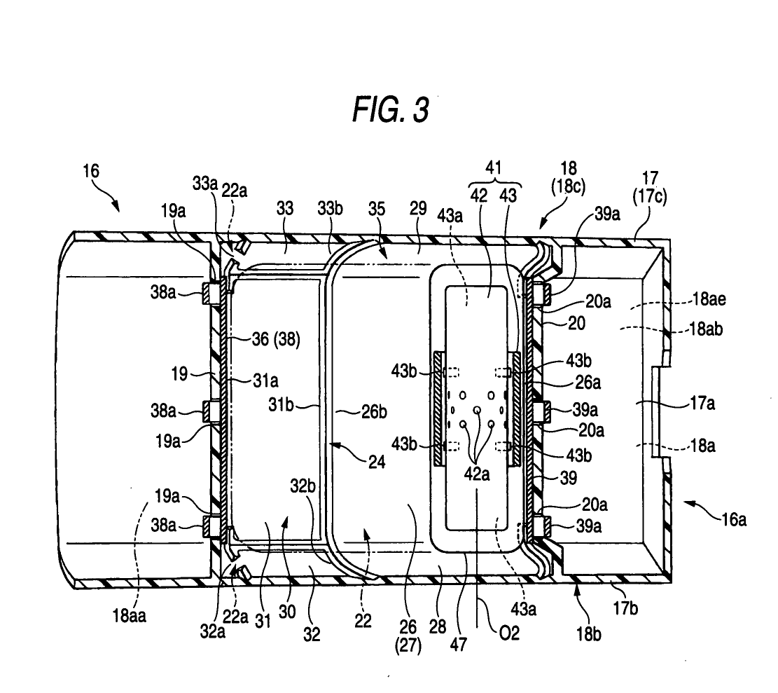

Additionally, in the first embodiment, as illustrated in FIGS. 3, 5, and 11, an auxiliary door portion 30 to be force-opened toward the airbag 47 so as to increase the area of the projection opening 22 of the airbag 47 is provided at the front side of the door portion 26 in the column cover 16. The auxiliary door portion 30 has an auxiliary lower door part 31 placed in the bottom surface 18a of the column cover 16, an auxiliary door part 32 placed in the left-side surface 18b of the column cover 16, and an auxiliary right door part 33 placed in the right-side surface 18b of the column cover 16 so that the breakably preformed part 24 is disposed around each of the auxiliary door parts 31, 32, and 33. Each of the auxiliary door parts 31, 32, and 33 is provided so as to dispose an associated one of hinge parts 31a, 32a, and 33a, each of which is constituted by an integral hinge, on a front edge side thereof, and so as to be opened by frontwardly turning an associated one of rear edges 31b, 32b, and 33b.

As illustrated in FIGS. 2 and 3, mounting walls 19 and 20, which extend upwardly from a bottom wall 17a, are respectively formed on the front and rear edges of the area, in which the projection opening 22 is formed, in the column cover 16 by connecting both left and right edges of each of the mounting walls 19 and 20 to a left-side wall 17b and a right-sidewall 17c, respectively. The mounting walls 19 and 20, together with the case 36, constitute the accommodation part 35 which accommodates the folded airbag 47 and the inflator 41, in the column cover 16. Also, each of the mounting walls 19 and 20 serves as a wall surface of the case 36, which will be described later. A plurality of catching-holes 19a and 20a, into which catching-pieces 38a and 39a of the case 36 are respectively inserted, so that the peripheries of the mounting walls are caught by the catching-pieces 38a and 39a, are formed in the mounting walls 19 and 20.

Incidentally, the accommodation part 35, which accommodates the folded airbag 47 and the inflator 41, in the column cover 16 is constituted so that each of both the left and right sides of the accommodation part 35 is surrounded by associated ones of the left door part 28, the right door part 29, the auxiliary left door part 32 and the auxiliary right door part 33, that each of both front and rear sides of the accommodation part 35 is surrounded by associated ones of the side walls 38 and 39 of the case 36 and the mounting walls 19 and 20 of the column cover 16, that the top side of the accommodation part 35 is surrounded by a ceiling wall 37 of the case 36, and that the top side of the accommodation part 35 is surrounded by the lower door part 27 and the auxiliary lower door part 31.

As illustrated in FIGS. 2 to 4, the case 36 is cross-sectionally inverse-U-shaped and is made of sheet metal. The case 36 is configured to have a ceiling wall 37 and side walls 38 and 39 extending downwardly from the front and rear edges of the ceiling wall 37. A plurality of cross-sectionally J-shaped catching pieces 38a and 39a, which are respectively inserted into the catching holes 19a and 20a provided in the mounting walls 19 and 20 of the column cover 16 and connected to the mounting walls 19 and 20, are formed in the side walls 38 and 39, respectively. A plurality (e.g., two in the first embodiment) of through-holes 37a to be respectively passed through mounting-bolts 44 of the inflator 41 are formed in the ceiling wall 37.

The case 36 constitutes the top side of the accommodation part 35 which accommodates and holds the inflator 41 and the airbag 47, and the top sides of both the front and rear side portions thereof. The case 36 is attached to the column tube 5 of the steering column 3. Further, in the first embodiment, the case 36 is attached and fixed to a bracket 5a of the column tube 5 by utilizing the mounting bolts 44 of the inflator 41, which are used to attach and fix the airbag 47 to the case 36. Additionally, in the first embodiment, the case 36 is disposed so that the two through-holes 37a, 37a are placed at the rear edge side of the ceiling wall 37 and are laterally provided side by side so that the inflator 41 is deviated to a backward side (see FIG. 4).

As illustrated in FIGS. 2 to 4, the inflator 41 includes a cylindrical body 42 of the cylinder type having a plurality of gas discharge ports, from which gas is discharged, and a retainer 43 made of sheet metal used to attach and fix the airbag 47 to the case 36. The body 42 is configured so that when the air bag device is mounted in a vehicle, the plural gas discharge ports 42a are disposed in a central portion in a lateral direction of the body 42 by setting an axial direction O2 (see FIG. 3) to extend along the lateral direction. The retainer 43 is substantially cylindrically-shaped so that an axial direction O2 of the retainer 43, which extends along the lateral direction that coincides with the axial direction O2 of the body 42. The retainer 43 has the plural mounting-bolts 44 (two bolts in the first embodiment) which upwardly extend and are provided side by side along the lateral direction (see FIG. 4). The mounting-bolts 44 constitute mounting means for mounting the body 42 of the inflator 41 in the case 36 serving as the accommodation part 35. Openings 43a for flowing inflation gas, which is discharged from the gas discharge ports 42a, to lateral external spaces are respectively formed in both lateral ends of the retainer 43, a bottom surface side of each of which is formed as a halved cylinder by being partly cut away. Also, a sandwiching portion 43b, which is reduced in diameter, is formed in the proximity of a center in the lateral direction of the retainer 43 so as to be able to hold the body 42 when inserted thereinto.

Incidentally, in the first embodiment, the mounting bolts 44 of the retainer 43 constitute the mounting means for mounting the inflator 41 in the case 36, as having already been described. Also, the mounting bolts 44 serve to fasten the inflator 41 and the airbag 47 together to the case 36, and also serve to attach the case 36 itself to the bracket 5a of the column tube 5 of the steering column 3 by being fastened thereto with a nut 45.

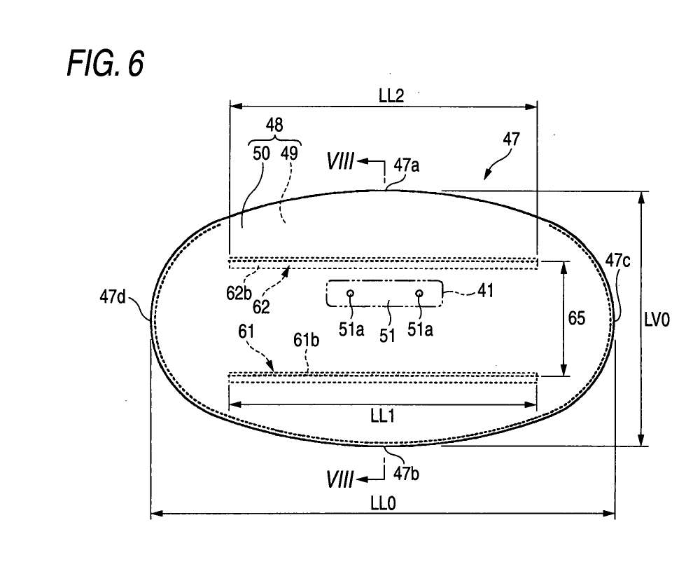

As illustrated in FIGS. 6 to 11, the airbag 47 is configured to form the shape of the airbag 47 at the completion of inflation thereof like a substantially horizontally long rectangle plate so that the lateral length of the shape is longer than the anteroposterior length thereof, and that the shape protrudes from both lateral sides of the column cover 16. The outer peripheral wall 48 includes a driver-side wall portion 49 which is placed at the side of a driver D at the completion of inflation thereof, and a column-side wall portion 50 placed at the side of the column cover 16. The driver-side wall portion 49 and the column-side wall portion 50 are made of flexible woven cloth including polyester and polyamide. The airbag 47 of the flat surface airbag type is formed by cutting the woven cloth so that the driver-side wall portion 49 and the column-side wall portion 50 have the substantially rectangular outer shape extending in the lateral direction, and by also sewing the peripheries of these portions.

Additionally, as illustrated in FIG. 6, two mounting holes 51a, through each of which the mounting bolt 44 of the inflator 41 is passed, are provided in the proximity of the center in anteroposterior direction and in a lateral direction side by side along the lateral direction. Further, in the first embodiment, the airbag 47 is attached to the case 36 and to the column tube 5, utilizing the inflator 41. Accordingly, a region, in which the inflator 41 is disposed, around each of the mounting holes 51a, 51a is sandwiched by the ceiling wall 37 of the case 36 and the retainer 43 of the inflator 41 when each of the bolts 44 is fastened with the nut 45. Thus, the mounting portion 51 to be attached to the case 36 is constructed.

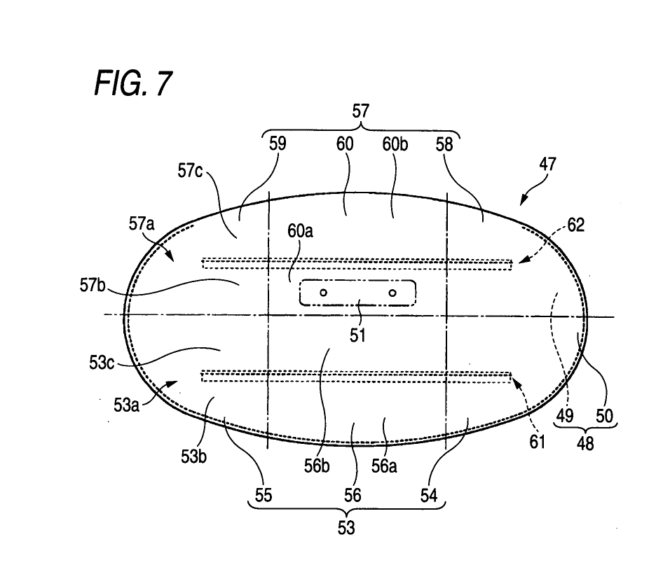

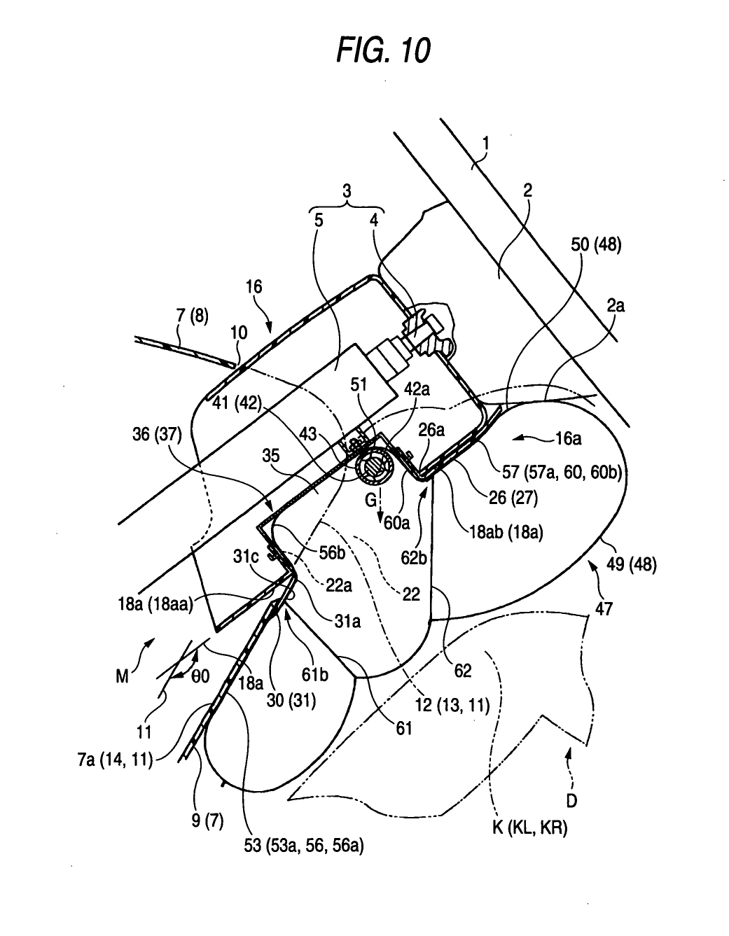

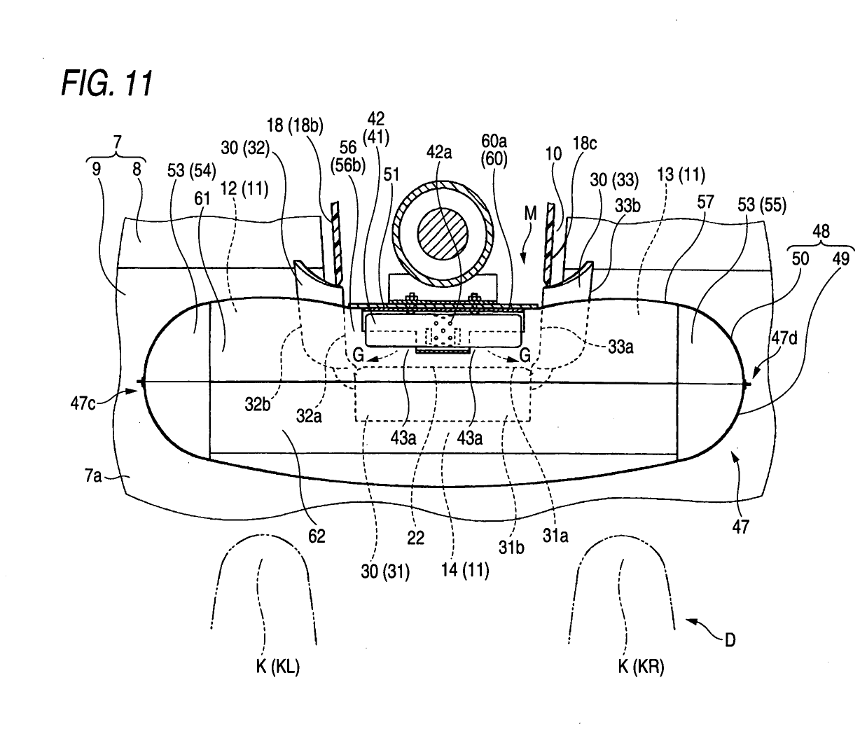

Therefore, as illustrated in FIGS. 10 and 11, in the first embodiment, the vicinity of the mounting portion 51 of the column-side wall portion 50 is accommodated in the accommodation part 35 at the completion of inflation of the airbag 47. As indicated by double-dash-chain lines in FIG. 1 and as illustrated in FIG. 10, the column-side wall portion 50 includes a front-side portion 53 and a rear-side portion 57, which are placed at anteroposterior positions of the vicinity of the center (i.e., the vicinity of the mounting portion 51) in the anteroposterior direction. Additionally, as illustrated in FIG. 7, the front-side portion 53 has a front-side left part 54 and a front-side right part 55, which are placed at both lateral sides, and a front-side central part 56 placed at the center in the anteroposterior direction. The rear-side part 57 has a rear-side left part 58 and a rear-side right part 59, which are placed at both lateral sides, and a rear-side central part 60 placed at the center in the anteroposterior direction.

Incidentally, in the first embodiment, as illustrated in FIG. 10, in a vehicle-mounted state in which the first embodiment is mounted in a vehicle, when the airbag 47 completes expansion/inflation, a rear part 56b of the front-side central part 56 of the front-side part 53 and a front part 60a of the rear-side central part 60 of the rear-side part 57 are placed in the accommodation part 35. The front part 56a of the front-side central part is closely attached to an area extending from a front edge (i.e., the hinge part 31a) of the projection opening 22 of the column cover 16 in the bottom surface 18a of the column cover 16 to a front-side bottom surface 18aa (more particularly, to a rear surface 31c of the auxiliary lower door portion 31, instead of the bottom surface 18aa, in the first embodiment, because the opened auxiliary lower door part 31 abuts against the periphery of the accommodation opening 10 so as to close the accommodation opening 10) and to the lower area 14 of the panel surface 11. A rear part 60b of the rear-side central part 60 is closely attached to an area extending from a rear edge (i.e., the hinge part 26a) of the projection opening 22 of the column cover 16 in the bottom surface 18a to a rear-side bottom surface 18ab (more particularly, to a rear-side bottom surface 18ab through a lower door part 27 of the opened door portion 26) and to the bottom surface 2a of the lower cover 2. Also, at the completion of inflation of the airbag 47 in the vehicle-mounted state, as illustrated in FIG. 11, the front-side left part 54 and the front-side right part 55 of the front-side portion 53 are closely attached to the left area 12 and the right area 13 through a part of the opened auxiliary left door part 32 and the opened auxiliary right door part 33, respectively. Incidentally, at the completion of inflation of the airbag 47 in the vehicle-mounted state, the rear left part 58 and the rear right area 59 are disposed in rear of the front-side left part 54 and the front-side right part 55. Thus, the rear left part 58 and the rear right area 59 are placed on both lateral sides of the column cover 16 to be apart frontwardly from the left area 12 and the right area 13 of the panel surface 11.

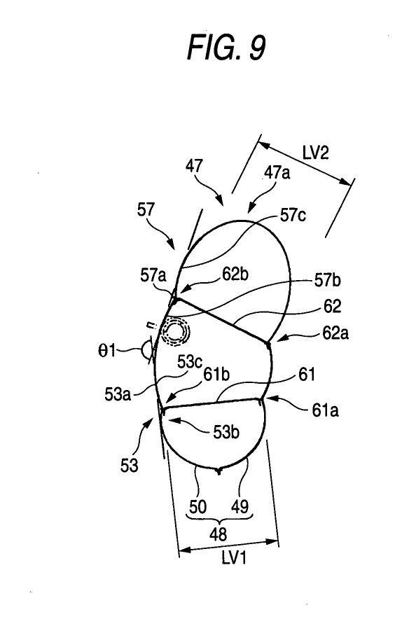

Further, in the airbag 47, the two tethers, that is, the front tether 61 and the rear tether 62 placed anterior and posterior to (or above and below) the mounting portion 51 are provided so as to connect the column-side wall portion 50 and the driver-side wall portion 49 to each other. The front tether 61 and the rear tether 62 are shaped like belts extend laterally. The position and the length dimension of each of the tethers 61 and 62 are set so that the intersection angle θ1 between the front surfaces 53a and 57a of the front-side portion 53 and the rear-side portion 57 at the completion of inflation of the single airbag 47 is substantially equal to the intersection angle θ0 between the panel surface 11 and the bottom surface 18a of the column cover 16 protruding from the panel surface 11 (see FIG. 9). Incidentally, in the first embodiment, the front surface 53a of the front-side portion 53 determining the intersection angle θ1 is formed in the vicinity of the center in the lateral direction as a surface put into contact with both the inflated parts 53b and 53c which are provided at both anteroposterior ends and are intervened by a connecting portion 61b of the front tether 61, which is connected to the column side wall portion 50. Also, a front surface 57a of the rear-side part 57 is formed in the vicinity of the center in the lateral direction of the column-side wall portion 50 as a surface contacted with both inflated parts 57b and 57c at both anteroposterior sides, which are intervened by a connection portion 62b of the rear tether 62, which is connected to the column side wall portion 50.

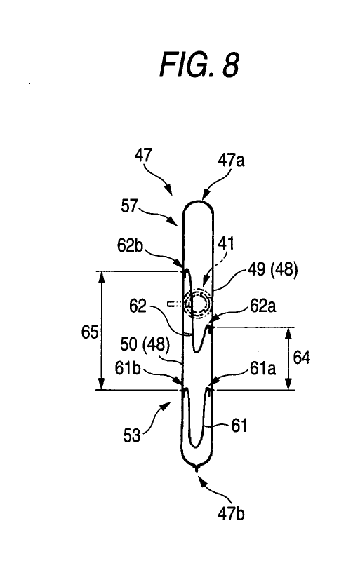

The front tether 61 and the rear tether 62 are arranged so that the connection portion 61b of the front tether 61, which is connected to the column-side wall portion 50, is connected to the front-side portion 53 in an area detached frontwardly from the accommodation part 35 at the completion of inflation of the airbag 47, and that the connection portion 62b of the rear tether 62, which is connected to the column-side wall portion 50, is connected to the rear-side part 57 in an area detached backwardly from the accommodation part 35 at the completion of inflation of the airbag 47 at the completion of inflation of the airbag 47 (see FIG. 10). Further, the front tether 61 and the rear tether 62 are provided so that the driver-side span 64 between the connecting parts (i.e., the connection portions) 61a and 62a, which are connected to the driver-side wall portion 49, is set to be shorter than the column-side span 65 between the connecting parts (i.e., the connection portions) 61b and 62b, which are connected to the column-side wall portion 50 (see FIG. 8).

Additionally, length dimensions LV1 and LV2 (see FIG. 9) of the front tether 61 and the rear tether 62, each of which connects the driver-side wall portion 49 to the column-side wall portion 50, are set so that the airbag 47 at the completion of inflation thereof can assure the plate-like rectangular shape. Also, length dimensions LL1 and LL2 (see FIG. 6) of the front tether 61 and the rear tether 62 are set at a value at which inflation gas discharged from the inflator 41 can be flown to both lateral sides.

The front tether 61 and the rear tether 62 are formed of flexible woven cloth including polyester and polyamide, similarly to the driver-side wall portion 49 and the column-side wall portion 50. Further, in the first embodiment, the front tether 61 and the rear tether 62 are provided so that the driver-side span 64 is set to be shorter than the column-side span 65. When the front tether 61 and the rear tether 62 are connected to the driver-side wall portion 49 and the column-side wall portion 50, the connection portions 61a and 61b of the front tether 61, which are respectively connected to the driver-side wall portion 49 and the column-side wall portion 50, are positioned so that the distances from the front edge (or bottom edge) 47b of the airbag 47 (i.e., the front edge 47b of the airbag 47 in the boundary part between the driver-side wall portion 49 and the column-side wall portion 50) thereto are set to be equal to each other. The connection portion 62a of the rear tether 62, which is connected to the driver-side wall portion 49, is positioned so as to be closer to the front edge 47b of the airbag 47 than the connection portion 62b thereof, which is connected to the column-side wall portion 50. That is, the connection portion 62a of the rear tether 62, which is connected to the driver-side wall portion 49, is positioned to be apart from the rear edge 47a of the airbag 47 than the connection portion 62b of the column-side wall portion 50.

Then, the airbag 47 is configured to assure anteroposterior and lateral dimensions at which the airbag 47 can cover the rear surface 31c of the auxiliary lower door part 31, and the rear-side bottom surface 18ab at the front and rear sides of the projection opening 22 in the bottom surface 18a of the column cover 16 protruding backwardly from the instrument panel 7 toward the knees KL and KR of a driver D and the left area 12, the right area 13, and the lower area 14 of the panel surface 11 on the periphery of the accommodation opening 10 in the rear surface 7a of the instrument panel 7 at the completion of inflation of the airbag 47 (see FIGS. 10 and 11). Furthermore, a vicinity of the rear edge (or top edge) of the airbag 47 at the completion of inflation of the airbag 47 is placed at a position at which the vicinity of the rear edge cover the bottom surface 2a of the lower cover 2 which covers a bottom surface of the steering wheel 1. Incidentally, in the first embodiment, the length dimension LL0 in the lateral direction of the airbag 47 expanded flat is about 600 mm which is about twice the length dimension LV0 in the anteroposterior direction (see FIG. 6). Also, the length dimension LV1 between the connection portions 61a and 61b of the front tether 61 is set to be about 50 mm. The length dimension LV2 between the connection portions 62a and 62b of the rear tether 62 is set to be about 75 mm. The lateral dimensions LL1 and LL2 of the front tether 61 and the rear tether 62 are set to be about 400 mm.

The airbag 47 is manufactured as follows. That is, a piece of an airbag foundation cloth, which is formed to connect the driver-side wall portion 49 to the column-side wall portion 50 and is expanded flat, is folded along a rear edge 47a of the airbag 47, which serves as a folding line, into two. Overlapped outer peripheries thereof are sewn to be connected to each other. At that time, the connection portions 61a, 61b, 62a, and 62b of the front tethers 61 and 62 are connected to the driver-side wall portion 49 and the column-sidewall portion 50. Additionally, at that time, the mounting bolt 44 is protruded from the mounting hole 51a preliminarily provided in the column-side wall portion 50, so that the inflator 41 is accommodated in the airbag. An operating signal input lead wire extending from the inflator 41 is protruded from a passing hole (not shown) in the proximity of the mounting hole 51a.

Incidentally, the airbag foundation cloth constituting the airbag 47 can be two pieces of cloth, which respectively constitute the driver-side wall portion 49 and the column-side wall portion 50, respectively.

Next, an operation of mounting the knee-protecting airbag device M according to the invention is described below. First, the airbag 47 accommodating the inflator 41 is folded. In the first embodiment, this folding operation is performed so that the inflator 41 is provided to the rear end of the accommodation part 35. The cloth is folded so that a left edge 47c and a right edge 47d on both lateral sides of the airbag 47 are frontwardly directed. In this state, the lateral width dimension is reduced according to the width dimension in the lateral direction and the anteroposterior direction of the accommodation part 35. Also, the anteroposterior width dimension is reduced by roll-folding the front edge side of the airbag 47. Thus, the operation of folding the airbag 47 is completed.

Then, when the folding of the airbag 47 is completed, the airbag 47 is wrapped with a predetermined folding-collapse-preventing wrapping material (not shown) so as not to cause folding collapse. Subsequently, the folded airbag 47 and the inflator 47 are accommodated in a space between side walls 38 and 39 of a case 36 at the bottom surface of a ceiling wall 37 while the mounting-bolt 44 for the inflator 41 is passed through the through hole 37a. A spring nut (not shown) is attached to each of the mounting-bolts 44. Thus, the airbag 47 and the inflator 41 are assembled to the case 36 so as to form an airbag assembly SA.

The assembled airbag assembly SA is attached and fixed to a bracket 5a of a column tube 5 of the steering column 3 by fastening each of the mounting-bolts 44 with the nut 45. A lead wire (not shown) extending from the inflator 41 is connected to an airbag operating circuit. Then, the column cover 16 is attached to the steering column 3 while catching pieces 38a and 39a are caught in mounting-walls 19 and 20 by inserting catching pieces 38a and 39a into catching holes 19a and 20a, respectively. Thus, the knee-protecting airbag device M can be mounted in a vehicle.

Then, in the knee-protecting airbag device M according to the first embodiment, when operated, inflation gas G is discharged from a gas discharge port 42 of a body 42 of the inflator 41. The inflation gas G is supplied from openings 43a at both lateral ends of a retainer 43 to the airbag 47. Further, when the airbag 47 is supplied with inflation gas G, the airbag 47 push-opens a door portion 26 and an auxiliary door portion 30 so as to open a projection opening 22. Then, the airbag 47 is protruded to both lateral sides from the accommodation part 35 provided in the column cover 16 while expands and inflates obliquely downwardly from the accommodation part 35. The airbag 47 is disposed in front of knees KL and KR of a driver D so as to cover a front-side bottom surface 18aa, a rear-side bottom surface 18ab, and a left area 12, a right area 13, and a lower area 14 of a panel surface 11, which is a rear surface 7a of the instrument panel 7, on each of the through an auxiliary lower door part 31 in the bottom surface 18a of the column cover 16, and a lower door part 27 of the door portion 26.

At that time, although entering the accommodation part 35 of the column cover 16 in the vicinity of a mounting portion 51 placed in the proximity of the center in the anteroposterior and lateral directions on the column-side wall portion 50 of the column cover 16, a portion in the vicinity of the periphery of the accommodation part 35, which is detached from the projection opening 22 of the accommodation part 35, that is, a rear part 60b of a rear-side central part 60 in a rear-side part 57 of the column-side wall portion 50 placed in rear of the accommodation part 35 is closely attached to the rear-side lower surface 18ab of the bottom surface 18a of the column cover 16 through the lower door part 27 of the opened door portion 26. The rear part 60b is closely attached to the bottom surface 2a of the lower cover 2. At that time, a front-side portion 53 and a rear-side portion 57 placed at the anteroposterior positions of the center in the anteroposterior direction of the column-side wall portion 50 are configured so that at the completion of inflation of the single airbag 47, the intersection angle θ1 between the front surfaces 53a and 57a of the front-side portion 53 and the rear-side portion 57 is substantially equal to the intersection angle θ0 between the panel surface 11 and the bottom surface 18a of the column cover 16 protruded form the panel surface 11.

Accordingly, in a case where the rear part 60b of the rear-side central part 60 of the rear-side part 57 of the column-side wall portion 50 is closely attached to the rear-side bottom surface 18ab of the rear-side periphery of the projection opening 22 of the column cover 16 through the lower door part 27, a part of the front-side portion 53 of the column-side wall portion 50, which is detached from the projection opening 22 of the accommodation part 35, is easily and closely attached to the panel surface 11 placed at each of both lateral sides of the column cover 16 from below the column cover 16. That is, the front part 56a of the front-side central portion 56 of the front-side portion 53 of the column-side wall portion 50 placed at the bottom side of the column cover 16 is closely attached to a lower area 14 below the column cover 16 in the panel surface 11 (see FIG. 10). Further, the front-side left part 54 and the front-side right part 55 at both lateral sides of the front-side portion 53 of the column-side wall portion 50 placed at both lateral sides of the column cover 16 are closely attached to the left area 12 and the right area 13 of the panel surface 11 placed at both lateral sides of the column cover 16 through a part of the auxiliary left door part 32 and the auxiliary right door part 33 (see FIG. 11).

Incidentally, in the first embodiment, the rear part 56b of the front-side central part 56 is drawn into the accommodation part 35. The front part 56a of the front-side central part 56 is closely attached to the front-side bottom surface 18aa (more particularly, the rear surface 31c of the auxiliary lower door part 31) placed in front of the front edge (i.e., the hinge part 31a) of the projection opening 22 of the column cover 16.

Further, in the first embodiment, the front-side portion 53 and the rear-side portion 57 in the column-side wall portion 50 of the airbag 47 can be closely attached to the left area 12, the right area 13, and the lower area 14 of the panel surface 11, and to the rear-side bottom surface 18ab of the bottom surface 18a of the column cover 16, without floating so as to be detached therefrom, through the door portions (i.e., the lower door part 27, the auxiliary lower door part 31, the auxiliary left door part 32, and the auxiliary right door part 33) of the door portion 26) to thereby enhance support of the airbag. Accordingly, even when the knees KL and KR of the driver D, which perform front movement and obliquely upward movement, are caught by the driver-side wall portion 49, that is, a part placed in rear of the front-side portion 53 and the rear-side portion 57 of the airbag 47, the knees are quickly supported by the left area 12, the right area 13, and the lower area 14 of the panel surface 11, and the rear-side bottom surface 18ab of the bottom surface 18a of the column cover 16. Consequently, the device can smoothly assure cushioning ability and catch the knees KL and KR.

Therefore, in the knee-protecting airbag device M according to the invention, the airbag 47 at completion of inflation thereof is closely and smoothly attached to the rear surface 7a of the instrument panel 7, and to the bottom surface 18a of the column cover 16. Accordingly, the airbag can quickly assure cushioning action and catch the knees KL and KR.

Further, in the airbag 47 according to the first embodiment, the front-side portion 53 and the rear-side portion 57 are not bent by surrounding-members. The airbag 47 according to the first embodiment ensures a bent shape as a shape of the airbag 47 at the completion of inflation of the airbag 47 itself at the completion of inflation thereof. Because no unnecessary pressing force is applied to the outer peripheral wall of the airbag at the completion of inflation thereof, damages due to interference with the surrounding-members, which may cause gas leakage, are hard to occur.

Additionally, according to the first embodiment, the intersection angle θ1 between the front surface 53a of the front-side portion 53 and the front surface 57a of the rear-side portion 57 of the column-side wall portion 50 of the airbag 47 is set by the front tether 61 and the rear tether 62 which are provided in the airbag 47 and which respectively extend from the front-side portion 53 and the rear-side portion 57 and determine the thickness of the airbag at the completion of inflation of the airbag by being connected to the driver-side wall portion 49. Thus, as compared with the case of three-dimensionally cutting a foundation cloth for an airbag and setting the intersection angle θ1 between the front-side portion 53 and the rear-side portion 57 of the column-side wall portion 50, when an airbag is manufactured by sewing and gluing foundation cloths for the airbag, it is sufficient to simply connect the connection portions 61a, 61b, 62a, and 62b of the front tether 61 and the rear tether 62 to the driver-side wall portion 49 and the column-side wall portion 50, without three-dimensionally performing a connecting operation, such as sewing. Consequently, an airbag can easily be manufactured.

More particularly, the airbag 47 is constituted as a flat type airbag in which the driver-side wall portion 49 and the column-side wall portion 50 have the substantially same outer shape. The front tether 61 and the rear tether 62 are provided so that the driver-side span 64 between connection parts (i.e., the connection portions 61b and 62b) of the front tether 61 and the rear tether 62, which are connected to the driver-side wall portion 49, is set to be shorter than the column-side span 65 between connection parts (i.e., the connection portions 61a and 62a) of the front tether 61 and the rear tether 62, which are connected to the column-side wall portion 50. Thus, the spans between the connection parts for connecting the front tether 61 and the rear tether 62 to the column-side wall portion 49 and the driver-side wall portion 50 are set so that the driver-side span 64 corresponding to the side of the driver side wall portion 49 is set to be shorter than the column-side span 65 corresponding to the column-side wall portion 50. Consequently, the connection portions 61a, 61b, 62a, and 62b at both ends of each of the front tether 61 and the rear tether 62 are connected to the column-side wall portion 49 and the driver-side wall portion 50. Then, the column-side wall portion 50 and the driver-side wall portion 49 are flatly expanded to overlap with each other. Thus, the peripheries of the column-side wall portion 50 and the driver-side wall portion 49 are connected to each other by sewing or the like. Consequently, an airbag 47 can extremely easily be manufactured by a planar connecting operation.

Also, in the first embodiment, the projection opening 22, from which the inflated airbag 47 is protruded, is arranged from the below the accommodation part 35 to the lateral side surfaces of the column cover 16 to extend in both lateral directions of the accommodation part 35 from below the accommodation part 35. Thus, the airbag 47 can be protruded from both the lateral side surfaces, that is, the left-side surface 18b and the right-side surface 18c of the column cover 16, which approach closer to the panel surface 11. Thus, the front-side portion 53 of the column-side wall portion 50 at the completion of inflation of the airbag can be more closely attached to the left area 12 and the right area 13 of the panel surface 11, which approach closely to and are in proximity of the column cover 16.

Incidentally, in the first embodiment, the intersection angle θ0 between the panel surface 11 and the bottom surface 18a of the column cover 16 protruding from the panel surface 11 is set to be about 160°. The intersection angle θ1 between the front surface 53a and 57a of the front-side portion 53 and the rear-side portion 57 in the column-side wall portion 50 at the completion of inflation of the single airbag 47 is set to be about 160°. However, at the completion of inflation of the airbag in the vehicle-mounted state, the column-side wall portion 50 is drawn into the accommodation part 35 so that the column-side wall portion 50 can be tucked. Thus, the area of each of the front surface parts 53a and 57a detached from the accommodation part 35 is reduced. Also, parts of the driver-side wall portion 49, which face each other in an up-down direction, inflate in a free space. Accordingly, the front surface parts 53a and 57a detached from the accommodation part 35 are liable to be pushed against the rear-side bottom surface 18a of the column cover 16 and against the lower area 14, the left area 12, and the right area 13 of the panel surface 11. Consequently, the intersection angle θ1 between the front surfaces 53a and 57a of the front-side portion 53 and the rear-side portion 57 the column-side wall portion 50 at the completion of inflation of the single airbag 47 can be smaller than the intersection angle θ0 between the panel surface 11 and the bottom surface 18a of the column cover 16 protruding from the panel surface 11 by about 10°. Apparently, in a case where the adhesion between the front surface part and each of the lower area 14, the left area 12, and the right area 13 of the panel surface 11 is favorable at the completion of inflation of the airbag in the vehicle-mounted state, the intersection angle θ1 between the front surfaces 53a and 57a can be slightly larger than the intersection angle θ0 between the panel surface 11 and the bottom surface 18a of the column cover 16 protruding from the panel surface 11 by about 5°. Therefore, it is advisable to appropriately set the intersection angle θ1 within a range of (−5°) to (+10°) from the intersection angle θ0. In a case where the intersection angles θ0 and θ1 are equal to each other, the steering column 3 is constituted by mounting a telescopic mechanism therein. Even in a case where the accommodation part 35, to which the column cover 16 and the airbag 47 are attached, is shifted in the anteroposterior direction, when the inflation of the airbag 47 is completed in the vehicle-mounted state, the airbag 47 can easily and closely be attached to the lower area 14, the left area 12, and the right area 13 of the panel surface 11 in a state in which the adhesion between the airbag 47 and the rear-side bottom surface 18ab of the column cover 16 is assured. Thus, the airbag device according to the invention is preferable.

Also, in the foregoing description of the first embodiment, the following case has been described. That is, regarding the front surfaces 53a and 57a of the front-side portion 53 and the rear-side portion 57 of the column-side wall portion 50 at the completion of inflation of the single airbag 47, the front surface 53a of the front-side portion 53 is formed as a surface to be contacted in the vicinity of the center in the lateral direction of the column-side wall portion 50 with both the inflated parts 53b and 53c at both the anteroposterior positions, which are intervened by the connection portion 61b of the front tether 61 to be connected to the column-side wall portion 50. Additionally, the front surface 57a of the rear-side portion 57 is formed as a surface to be contacted in the vicinity of the center in the lateral direction of the column-side wall portion 50 with both the inflated parts 57b and 57c at both the anteroposterior positions, which are intervened by the connection portion 62b of the rear tether 62 to be connected to the column-side wall portion 50. However, in a case where the front surfaces 53a and 57a are determined in a different manner, at the completion of inflation of the airbag 47 in the vehicle-mounted state, a surface obtained by averaging parts, on each of which the front-side portion 53 is widely surface-contact with the panel surface 11, can be set to be the front surface 53a. Also, a surface obtained by averaging parts, on each of which the front-side portion 57 is widely surface-contact with the periphery of the rear edge of the projection opening 22, can be set to be the front surface 57a. The angle between the front surfaces 53a and 57a at the completion of inflation of the single airbag 47 can be set to be the intersection angle θ1.

Also, the panel surface 11 and the bottom surface 18a of the column cover 16 may be formed like a curved surface that is slightly downwardly inflated. In such a case, each of the panel surface 11 and the bottom surface 18a is replaced with a surface obtained by averaging areas with which the vehicle-mounted airbag 47 at the completion of inflation thereof is contacted. Additionally, an angle formed between the surfaces, with which the panel surface 11 and the bottom surface 18a are respectively replaced, is set as the intersection angle θ0.

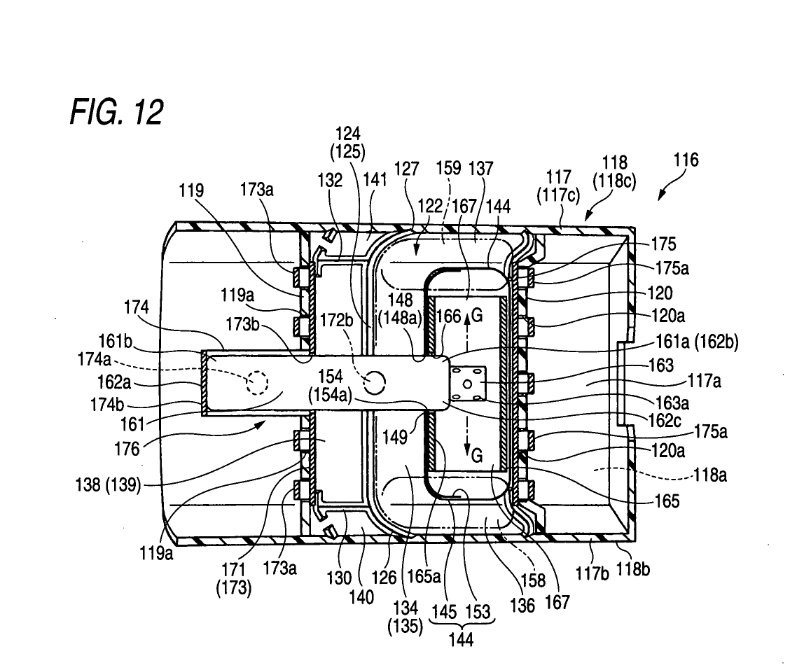

A second embodiment is a knee-protecting airbag device. As illustrated in FIG. 12, the airbag device M1 is configured so that a lower portion of a column cover 116 is a mounting part, and that a folded airbag 144 is accommodated in the lower portion of the column cover 116. Also, the knee-protecting airbag device is configured to have the folded airbag 144, an inflator 161 for supplying inflation gas to the airbag 144, and a case 171 for accommodating the airbag 144, and the inflator 161. The inflated airbag 147 push-opens a door portion 134 provided in the column cover 116 and is disposed in front of left and right knees of a seated driver.

As illustrated in FIG. 12, the column cover 116 is shaped into a substantially quadrangularly cylinder, and is made of a synthetic resin. The column cover 16 is attached to a column tube of the steering column at a part (not shown) thereof, and protrudes backwardly from an accommodation opening of an instrument panel. Additionally, the column cover 116 is provided in front of the seated driver. Incidentally, the steering column is configured to have a main shaft and the column tube disposed therearound. A steering wheel is connected to the main shaft. The instrument panel includes an upper panel provided at the top side, and a lower panel provided at the bottom side.

As illustrated in FIG. 12, a door portion 134 to be opened by being pressed by the airbag 144, is provided in the column cover 116 so that the single projection opening 122, from which the airbag 144 protrudes, can be formed in an area extending from the bottom surface 118a of an outer peripheral surface 118 to each of the a left-side surface 118b and aright-side surface 118c. The door portion 134 is placed in rear of the rear surface of the instrument panel and has a lower door part 135 placed at the side of the bottom surface 118a of the column cover 116, a left door part 128 placed at the side of the left-side surface 118b of the column cover 116, and a right door part 137 placed at the side of the right-side surface 118c of the column cover 116. A breakably preformed part 124, which can be broken by being pressed by the inflated airbag 144, is formed around the door portion 134.

The breakably preformed part 124 is constituted by providing a linearly continuous and concave groove in an inner peripheral surface of the column cover 116 so as to reduce the thickness of the column cover 116. The breakably preformed part 124 has a transverse line part 125 provided along a lateral direction in a bottom wall 117a of a peripheral wall 117 of the column cover 116, a left edge line part 126 provided in a left side wall 117b and a right side wall 117c of the column cover 116 so as to extend like an inverse-U from both lateral ends of the transverse line part 125, and a right edge line part 127. The transverse line part 125 constitutes a front edge side of the lower door part 135. The left edge line part 126 and the right edge line part 127 constitute outer peripheral edges of the left door part 136 and the right door part 137.

Then, the lower door part 135 has a part connecting rear-edge-side ends of the left edge line part 126 and the right edge line part 127, which are apart from the transverse line part 125, as a hinge part so that a front edge side part is turned downwardly and backwardly, and that the lower door part 135 is opened downwardly. The left door part 136 and the left door part 137 are provided so that hinge parts are disposed at lateral edge positions of the lower door part 135, that is, intersection parts between the bottom wall 117a and each of the left-side wall 117b and the right-side wall 117c of the column cover 116 before the door portion 134 is opened, and that the door portion 134 is opened by downwardly turning the top edges.

Incidentally, in the second embodiment, the left door part 136 and the right door part 137 are configured so that the hinge parts are placed at the lateral edges of the lower door part 135 and are connected to each other, as compared with a case where the lower door part 135 is opened downwardly and backwardly. Thus, when the lower door part 135 completes an opening operation to a fully open condition by employing the hinge part as the center of rotation so as to be brought into contact with the bottom surface 118a of the column cover 116, each of the left door part 136 and the right door part 137 completes an opening operation by disposing an associated one of the hinge parts at the side of the bottom edge so as to be contacted with an associated one of the left-side surface 118b and the right-side surface 118c.

Also, in the second embodiment, as illustrated in FIG. 12, an auxiliary door part 138 to be push-opened by the airbag 144 is provided in front of the door portion 134 in the column cover 116 together with the door portion 134 so as to increase the area of the projection opening 122 of the airbag 144. The auxiliary door part 138 includes an auxiliary lower door part 139 placed at the side of the bottom surface 118a of the column cover 116, an auxiliary left door part 140 placed at the side of the left surface 118b of the column cover 116, and an auxiliary right door part 140 placed at the side of the right surface 118c of the column cover 116. Each of the auxiliary lower door part 139, the auxiliary left door part 140, and the auxiliary right door part 141 is provided by disposing a hinge part at the side of the front edge so as to frontwardly turn the rear edge to be opened.

Then, an upper left line part 129, a lower left line part 130, an upper right line part 131, and a lower right line part 132 of the breakably preformed part 124 are disposed around the auxiliary door part 138. The upper left line part 129 frontwardly extends from a vicinity of the top portion inflated upwardly and constitutes an upper edge side of the auxiliary left door part 140. The upper right line part 131 frontwardly extends from a vicinity of the top portion inflated upwardly and constitutes an upper edge side of the auxiliary right door part 141. Further, the lower left line part 130 and the lower right line part 132 frontwardly extend from both the lateral ends of the transverse line part 125 and constitute both left and right edge sides of the auxiliary lower door part 139 (i.e., the lower edge sides of the auxiliary left door part 140 and the auxiliary right door part 141).

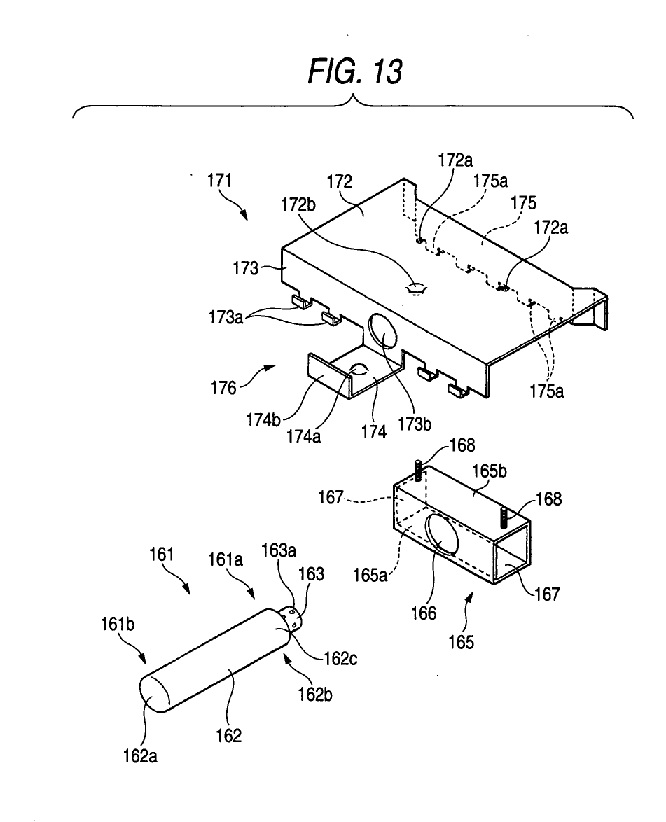

As illustrated in FIGS. 12 and 13, the mounting walls 119 and 120 upwardly extending from the bottom wall 117a by connecting both left and right edge sides to the left-sidewall 117b and the right-side wall 117c are formed on the anteroposterior edge portions of an area constituting the projection opening 122 in the column cover 116, respectively. A plurality of catching-holes 119a and 120a, into each of which an associated one of catching-pieces 173a and 175a of the case 171 is inserted, so as to cause the catching-pieces 173a and 175a to catch the peripheries thereof are formed in the mounting walls 119 and 120.

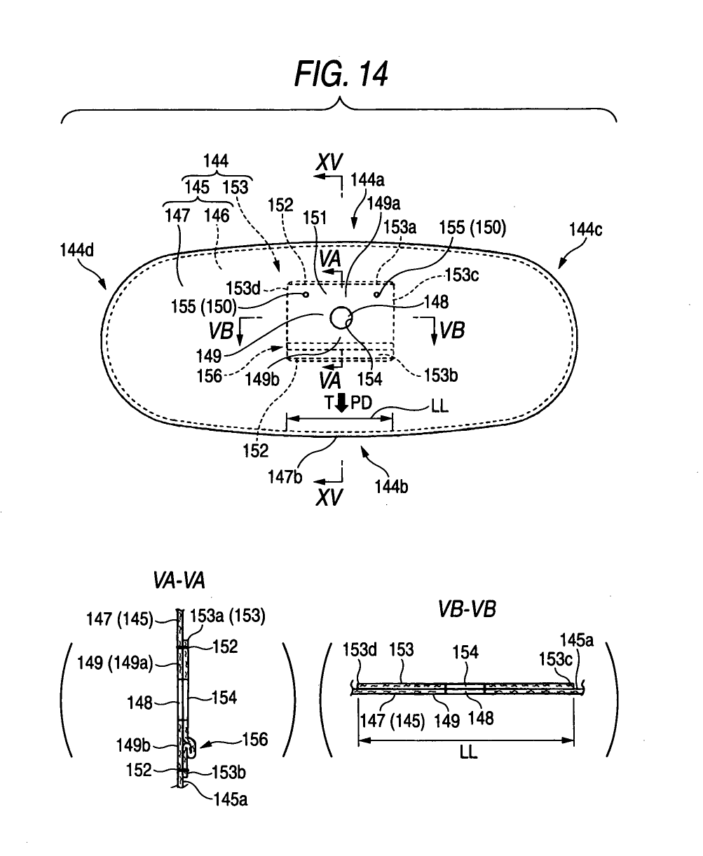

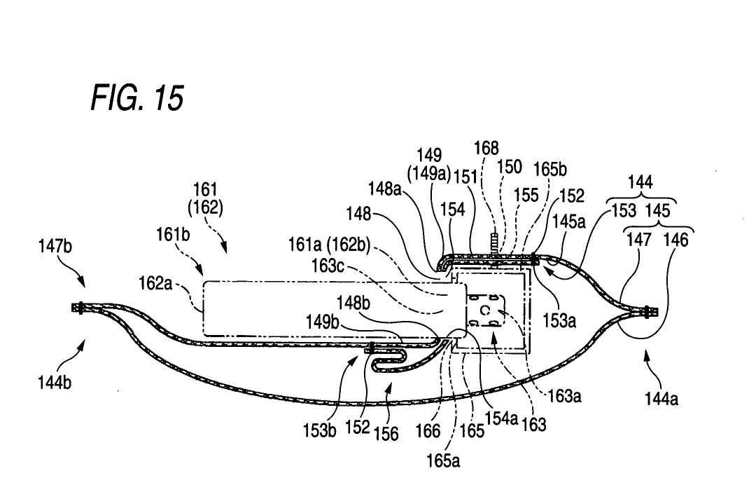

As illustrated in FIGS. 14 and 15, the airbag 144 is formed to have a laterally-elongated substantially-rectangular shape at completion of inflation thereof and is constituted to have an airbag body 145 and a seal cloth 153.

The airbag body 145 constitutes an outer peripheral wall of the airbag 144, and is shaped so as to be able to cover, at the completion of expansion/inflation of the airbag 145, the bottom surface 118a of the column cover 116 protruding rearwardly from the instrument panel toward the left and right knees of a driver and the rear surface of the lower part and both the lateral sides of the column cover 116, which is a bottom-edge-side periphery 111 of the projection opening. Then, the airbag body 145 is constituted by including a driver-side wall portion (i.e., an occupant-side wall portion) 146, which is disposed at the side of the drier at the completion of inflation of the airbag 144, and a column-sidewall portion (i.e., a vehicle-side wall portion) 147, which is disposed at the side of the drier D at the completion of inflation of the airbag 144, at the completion of inflation of the airbag 144. The driver-side wall portion 146 and the column-side wall portion 147 are formed by cutting woven cloth including polyester and polyamide so that the driver-side wall portion 146 and the column-sidewall portion 147 have the substantially same outer shape extending, and by also sewing the peripheries of these portions to constitute the outer peripheral wall of the airbag 144. Also, in the column-side wall portion 147, as illustrated in FIG. 14, a circularly-opened insertion hole 148, in which a rear end 161a (i.e., a rear end 162b of the body 162) having a gas discharge port 163 in the inflator 161 is inserted, is formed in the vicinity of the substantially center in an up-down direction (in an anteroposterior direction at the completion of inflation in the vehicle-mounted state) and in the lateral direction of the airbag 144. Mounting holes 150, from each of which an associated one of bolts 168 (see FIG. 13) of a diffuser 165 is protruded, are formed at each of both upward lateral sides of the insertion hole 148. The insertion hole 148 is circularly opened to have an inside diameter dimension at which the rear end 161a of the inflator 161 can be inserted into the insertion hole 148 without no space between the rear end 161a and an inner surface of the insertion hole 148.

Thus, the airbag 144 is mounted at the mounting part, which is at the side of a lower portion of the column cover 116, using the periphery of each of the mounting-holes 150 of the column-side wall portion 147 of the airbag body 144 as the attaching part 151. Incidentally, in the second embodiment, the attaching part 151 is attached to the column tube in the steering column together with the case 171, the inflator 161, and the diffuser 165, through the case 171, when fastened to the bracket of the column tube with the nut 169. Furthermore, in the second embodiment, the attaching part 151 of the column-side wall portion 147 (i.e., the airbag body 145, and the airbag 144) is sandwiched by a ceiling wall 165b of the diffuser 165 and a ceiling wall 172 of the case 171 (see FIG. 13), and is attached to the bracket. More particularly, the attaching part 151 is an area having an outer shape of the ceiling wall 165b of the diffuser 165 on the periphery of each of the mounting-holes 150, 150.

Further, the insertion hole 148 of the column side wall portion 147 in the airbag body 145 is positioned between the attaching part 151 and a projecting end 147b (i.e., the bottom edge of the column-side wall portion 147 shown in FIG. 14, or a front edge in the vehicle-mounted state) so that a tensile force T acts upon the periphery 149 of the insertion hole 148 at expansion/inflation of the airbag body 145. That is, in the second embodiment, the insertion hole 148 is provided between the bottom edge 144b (i.e., the projecting end 147b) of the airbag 144 and each of the mounting-holes 150 and 150 in the column-side wall portion 147. A direction PD of action of the tensile force T generated in the periphery 149 of the insertion hole 148 in the column-side wall portion 147 at the expansion/inflation is a downward direction directed from the insertion hole 148 to the bottom edge 144b of the airbag 144.

Incidentally, the airbag body 145 can be formed by two folding a piece of a cloth material which is obtained by connecting the driver-side wall portion 146 and the column-side wall portion 147 at a part of the periphery, and sewing the outer peripheries thereof.

Also, in the airbag body 145, tethers (not shown), which connect the driver-side wall portion 146 and the column-side wall portion 147 to each other and determine the thickness, are provided so as to be able to maintain a plate-like shape at the completion of inflation.

As illustrated in FIGS. 14 and 15, the seal cloth 153 is formed together with the driver-side wall portion 146 and the column-side wall portion 147 by cutting flexible woven cloth including polyester and polyamide to have a rectangular shape. In the second embodiment, the seal cloth 153 is attached to the periphery 149 of the insertion hole 148 formed in the inner peripheral surface side of the airbag body 145 by sewing using suture threads 152. A fitting hole 154, into which a rear end 161a (or rear end 162b of the body 162) having a gas discharge port 163a of the inflator 161 can be inserted, is provided in the seal cloth 153. Also, a through hole 155, through which the bolt 168 of the diffuser 165 is passed, is provided in an upper part of each of both the lateral sides of the fitting hole 154. The insertion hole 148 is circularly opened to have an inside diameter dimension at which the rear end 161a of the inflator 161 can be inserted into the insertion hole 148 without no space between the rear end 161a and an inner surface of the insertion hole 148. The fitting hole 154 is circularly opened to have an inside diameter dimension at which the rear end 161a of the inflator 161 can be fit without no space.

Further, the seal cloth 153 is configured so that in a state in which the rear end 161a of the inflator 161 is inserted (or fit) into the insertion hole 148 and the fitting hole 154, the top edge 153e of the periphery of the fitting hole 154 is attached to the top edge 149a, which is at a side in a direction opposite to the direction PD of action of the tensile force T of the airbag body 145, in the periphery 149 of the insertion hole 148 by sewing. Additionally, the top edge 153a and the bottom edge 153b are attached to the column-side wall portion 147 by sewing so as to provide a looseness 156 at the side of the bottom edge 149b at the generation of the tensile force T acting upon the periphery 149 of the insertion hole 148 at inflation of the airbag body 145, the bottom edge 153b can perform shift movement at ease integrally with the bottom edge 149b serving as a destination of movement in the periphery 149 of the insertion hole 148.

Incidentally, the stretched length of the looseness 156 is set at a value within a range that is longer than a maximum movement distance of the bottom edge 149b in the periphery 149 of the insertion hole 148 in a time period including a mid-course of the inflation and a moment at which the inflation is completed, so that waste of a material of the seal cloth 153 can be eliminated.

The lateral width dimension LL of the seal cloth 153 is set to be longer than a length dimension in an up-down direction of the seal cloth 153 expanded flat so that when the bottom edge 149b of the periphery 149 of the insertion hole 148 of the inflated airbag body 145 is moved, the left edge 153c and the right edge 153d are not convoluted. In the second embodiment, the left edge 153c and the right edge 153d of the seal cloth 153 are not attached to the column-side wall portion 147 by sewing. The left edge 153c and the right edge 153d of the seal cloth 153 are provided to simply overlap with the column-side wall portion 147.

As illustrated in FIGS. 12 to 13, the inflator 161 is configured to have a cylindrical body 162, and a cylindrical head part 163 which is smaller in diameter than the body 162 and is provided at the rear end 161a of the inflator 161. The head part 163 is provided with a plurality of gas discharge ports 163a for discharging inflation gas. The inflator 161 is attached to the mounting part by providing the rear end 162b of the body 162 in the vicinity of the head part 163 at the positions of the inner peripheral surfaces 148a and 154a of the insertion hole 148 of the airbag body 145 and the fitting hole 154 of the seal cloth 153.

The diffuser 165 for regulating a direction, in which inflation gas flows out of the gas discharge port 163a, is provided at the rear end 161a of the inflator 161. The diffuser 165 is shaped like a quadratic prism, in which an axial direction is set to be a lateral direction, and is formed of sheet metal. The diffuser 165 constitutes a gas flow control member for causing the inflation gas G contained in the airbag 144 (i.e., the airbag body 145) to flow out in an outward direction from the vicinity of the center in the lateral direction of the column cover 116 toward both lateral sides toward the left door part 136 and the right door part 137 respectively disposed in the left-side surface 118b and the right-side surface 118c.

Then, a circularly-opened assembly hole 166, into which the rear end 162b of the body 162 of the inflator 161 is inserted together with the head part 163, is formed in the vicinity of the center in the lateral direction of the front wall 165a. Openings provided at both lateral ends are constituted as discharge ports 167, 167 for causing the inflation gas to flow toward the left door part 136 and the right door part 137. Two bolts 168 protruding upwardly are provided side by side along the lateral direction in the ceiling wall 165b of the diffuser 165. Each of the bolts 168 is fastened to the bracket of the column tube with the nut 169.

As illustrated in FIGS. 12 and 13, the case 171 is cross-sectionally inverse-U-shaped and is made of sheet metal. The case 171 is configured to have a ceiling wall 172 and side walls 173 and 175 extending downwardly from the front and rear edges of the ceiling wall 172. A plurality of cross-sectionally J-shaped catching pieces 173a and 175a, which are respectively inserted into the catching holes 119a and 120a provided in the mounting walls 119 and 120 of the column cover 116 and connected to the mounting walls 119 and 120, are formed in the side walls 173 and 175, respectively. Through-holes 172a to be respectively passed by each of the bolts 168 of the diffuser 165 are formed in the ceiling wall 172.

Further, a holding portion 176 including a support seat 174, support projections 172, 174a, an insertion hole 173b, and a stop piece 174b is provided in this case 171 so as to simply hold the inflator 161. The insertion hole 173b is placed at the center in the lateral direction of the front-side wall 173 to have a size at which the body 162 of the inflator 161 can be inserted into the insertion hole 173b. Also, the support seat 174 is provided to frontwardly extend in parallel to the ceiling wall 172 from the bottom edge in the proximity of the bottom of the insertion hole 173b of the side wall 173. The stop piece 175a extending upwardly is provided at the front end of the ceiling wall 175a. Additionally, the support projection 172b is formed to protrude downwardly from the vicinity of the center in the anteroposterior direction of the ceiling wall 172 at the rear side of the insertion hole 173b. The support projection 174a is formed to upwardly protrude from the vicinity of the center in the anteroposterior direction of the support seat 174. The stop piece 174b restricts the position of an end surface 162a of the body 162 at the side of the front end 161b of the inflator 161. The support projections 172b and 174a abut against and support the body 162 from above and below. In this holding portion 176, when the bolt 168 of the diffuser 165 is fastened to the bracket with the nut 169, the inner peripheral surface of the assembly hole 166 of the diffuser 165 upwardly pushes the rear end 162a of the body 162. Thus, the support projections 172b and 174a perform leverage and firmly sandwich the body 162 from above and below. Thus, the inflator 161 is securely attached and fixed to the case 171 and the bracket.

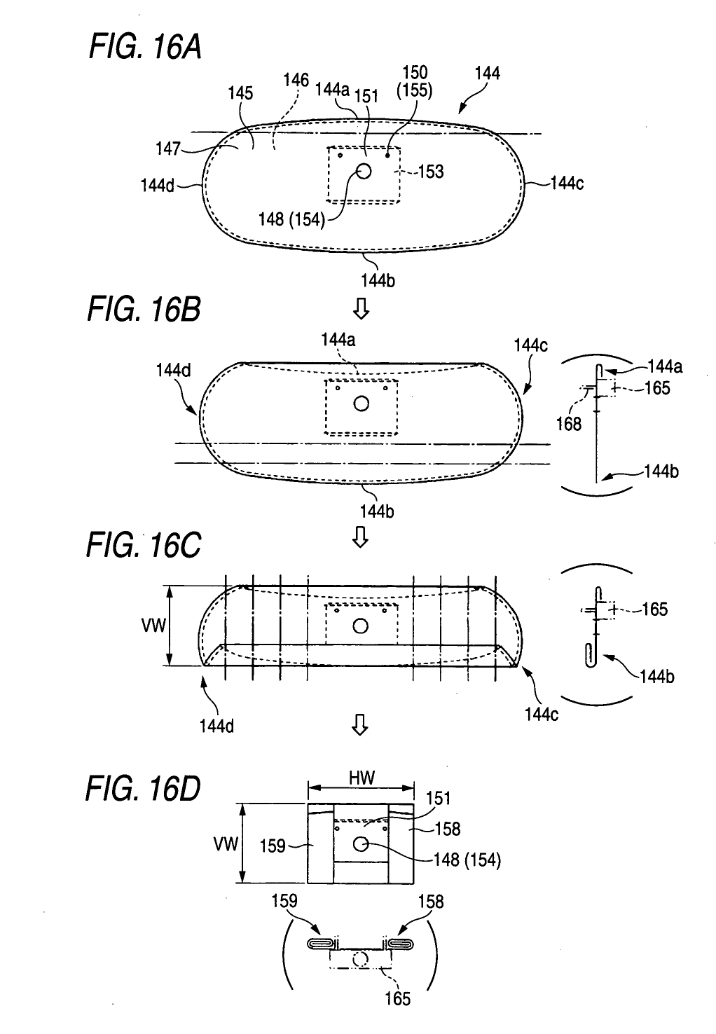

An operation of mounting the airbag device according to the second embodiment in a vehicle is described below. First, the airbag 144 is folded. As illustrated in FIGS. 16A to 16C, in the second embodiment, the column-side wall portion 147 is placed on the driver-side wall portion 146, and the airbag 144 is expanded flat. Then, the airbag 144 is folded so that the top edge 144a and the bottom edge 144b approach the center in the anteroposterior direction, and that an anteroposterior length dimension VW is reduced. Incidentally, preliminarily, in a state in which the bolts 168 are protruded from the attaching hole 150 and the through hole 155, the diffuser 165 is accommodated in the airbag 144. Then, this folding is performed. An operation of accommodating the diffuser 165 in the airbag 144 is performed by preliminarily providing the diffuser 165 in the airbag 144 in the course of manufacture of the airbag 144. Then, the outer edges of the driver-side wall portion 146 and the column-side wall portion 147 are sewn. Incidentally, the seal cloth 153 is already provided with the looseness 156, in the column-side wall portion 147.

Then, as illustrated in FIGS. 16C and 16D, the airbag 144 is folded so as to reduce the lateral width dimension HW of the airbag 144 and as to cause the left edge 144c and the right edge 144d to approach the center. In the second embodiment, the airbag is folded by roll-folding so that the left edge 144c and the right edge 144d are convoluted at the side of the column-side wall portion 147. When accommodated in the accommodation part, each of the lateral folded parts 158 and 159 is provided at the side of an associated one of the left edge 144c and the right edge 144d so as to face inflation gas flowing out of the diffuser 165 at the left door part 136 and the right door part 137 of the door portion 134 and as to close the discharge ports 167, 167 of the diffuser 165.

Upon completion of folding of the airbag 144, the airbag 144 is wrapped with a predetermined folding-collapse prevention wrapping material so as to prevent occurrence of folding-collapse. Subsequently, the rear end 161a of the inflator 161 is inserted into the assembly hole 166 of the inflator 161 through the insertion hole 148 and the fitting hole 154 of the airbag 144. Then, the bolts 168 protruding from the folded airbag 144 are inserted into the through holes 172a. Also, the front end 161b of the inflator 161 is inserted into the insertion hole 173b is inserted into the insertion hole 173b so as to protrude the front end 161b from the inside of the case 171 to the outside. Then, the front end 161b of the inflator 161 is placed on the support seat 174. Additionally, the end surface 162a of the body 162 in the front end 161b of the inflator 161 is made to abut against the stop piece 174b. Also, the folded airbag 144 is accommodated between the side walls 173 and 175 of the case 171 while the support projections 172b and 174a are made to abut against the outer peripheral surface of the body 162 of the inflator 161. Thus, an airbag assembly is formed.

Then, when this airbag assembly is mounted in a vehicle, the bolts 168 of the diffuser 165 are inserted into the bracket, and are fastened with the nut 169. Thus, the inner peripheral surface of the assembly hole 166 of the diffuser 165 serves as a point of application of a force for pushing up the body 162 of the inflator 161. Consequently, the body 162 is supported by support projections 172b and 174a, similarly to the case of a leverage, so as to be sandwiched from above and below. Accordingly, the inflator 161 is securely held by the case 171. Consequently, the case 171 and the diffuser 165 are attached and fixed to the bracket of the column tube of the steering column, together with the inflator 161. Further, a lead wire (not shown) extending from an airbag operating circuit is connected to the body 162 of the inflator 151. Then, the column cover 116 is attached to the steering column while mounting-walls 119 and 120 are caught by catching-pieces 173a and 175a, respectively. Thus, the knee-protecting airbag device can be mounted in a vehicle.

When the airbag device according to the second embodiment is operated after mounted in a vehicle, the inflator 161 discharges inflation gas G from the gas discharge port 163a at the side of the rear end 161a thereof. The inflation gas G is supplied from the discharge ports 167, 167 at both lateral sides of the diffuser 165 to the airbag 144. Then, when the inflation gas G is supplied to the airbag 144, as illustrated in FIG. 12, in the airbag 144, the diffuser 165 causes the inflation gas G to flow from the vicinity of the center in the lateral direction of the column cover 144 toward the left door part 136 and the right door part 137 of the door portion 134 in both outward lateral directions. The folding parts 158 and 159 pushed by the inflation gas G flowing outwardly to the lateral sides push-open the left door part 136, the right door part 137, the auxiliary left door part 140, and the auxiliary right door part 141. Then, the airbag 144 (i.e., the airbag body 145) accommodated by being folded in the column cover 116 is protruded from the lower portion of the column cover 116 at the mounting part to the outside in both the lateral directions in an initial stage of the inflation. Furthermore, the airbag 144 (i.e., the airbag body 145) is further supplied with the inflation gas G directed to both lateral sides. The airbag 144 is widely expanded to both lateral sides. Also, the airbag 144 is protruded from the mounting part by push-opening the lower door part 135 and the auxiliary lower door part 139 of the door portion 134. Then, the airbag 144 inflates to increase the thickness thereof. Thereafter, the airbag 144 completes inflation. Thus, the airbag 144 is disposed in front of the knees so as to be able to protect the lateral knees of the driver.

When the airbag body 145 inflates, the position of the periphery 149 of the insertion hole 148 of the airbag body 145 is regulated by the rear end 161a (i.e., the outer peripheral surface 162c of the rear end 162b of the body 162) of the inflator 161 attached to the bracket of the column tube in the mounting part. A tensile force T acts toward a direction in which the projecting end 147b (see FIG. 15) at the bottom edge side of the column-side wall portion 147 is protruded from the mounting part of the airbag body 145. A gap is generated between a part at the side in the direction of action of the tensile force Ton the inner peripheral surface 148a of the insertion hole 148 (i.e., a pull-side inner peripheral surface 148b at the side of the bottom edge 149b of the periphery 149) and the outer peripheral surface 162c of the inflator 161, which are intervened by the insertion hole 148.

However, the seal cloth 153 can perform relative shift movement with respect to the periphery 149 of the insertion hole 148 of the airbag body 145 while the looseness 156 is eliminated in a state in which the inflator 161 is fit into the fitting hole 154. Thus, the seal cloth 153 can cover the gap between the outer peripheral surface 162c of the inflator 161 and the pull-side inner peripheral surface 148b. Consequently, the inflation gas G can be prevented from leaking outwardly from the airbag 144 through the insertion hole 148. Accordingly, the gas sealability of the periphery 149 of the insertion hole 148 in the airbag body 145 can be assured.

Therefore, in the airbag device according to the second embodiment, favorable gas sealability of the periphery 149 of the insertion hole 148, into which the inflator is inserted, and on which the tensile force T acts at expansion/inflation of the airbag 144, can be obtained.

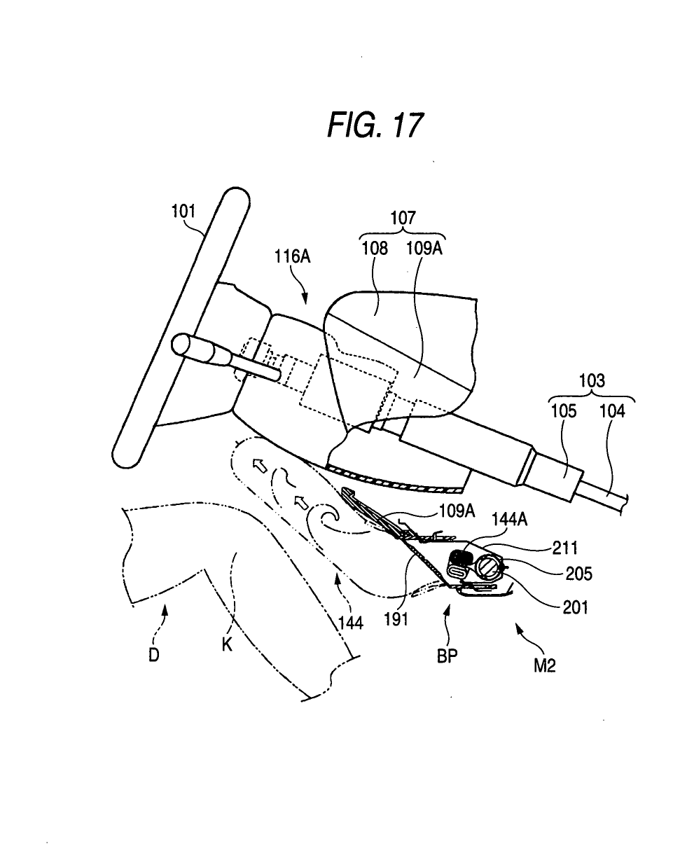

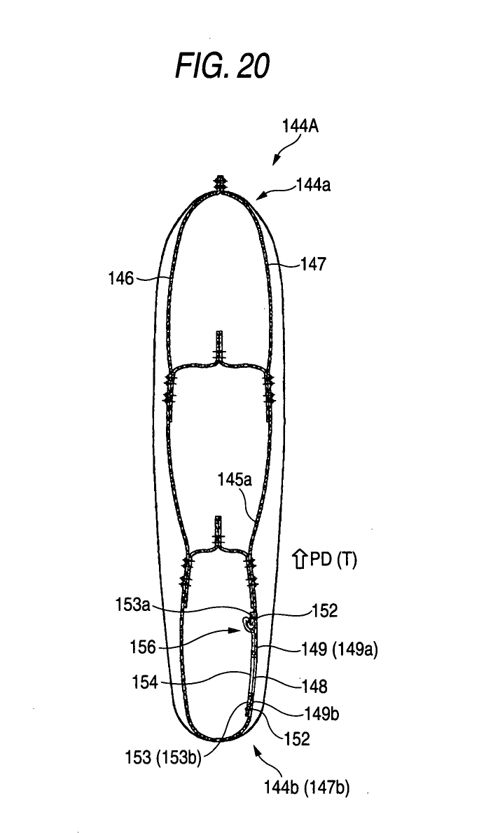

Incidentally, in the foregoing description of the second embodiment, it has been described that a part of the rear end 161a having the gas discharge port 163a in the inflator 161 is inserted into the airbag 144. Similarly to an airbag device M2 according to a third embodiment illustrated in FIGS. 17 to 21, most of a cylinder type inflator 201 can be inserted into the airbag 144A.

This airbag device M2 is a knee-protecting airbag device configured so that a space inside the lower panel 109A of the instrument panel 107 below a column cover 116A is used as the mounting part BP. The airbag device M2 can be configured to include an airbag 144A enabled to protect the left and right knees K of the driver D, an inflator 201 for supplying inflation gas to the airbag 144A, a case 211 made of metal sheet for accommodating the folded airbag 144A and the inflator 201, and a synthetic resin airbag cover 191 for covering an opening 212a of the case 211.

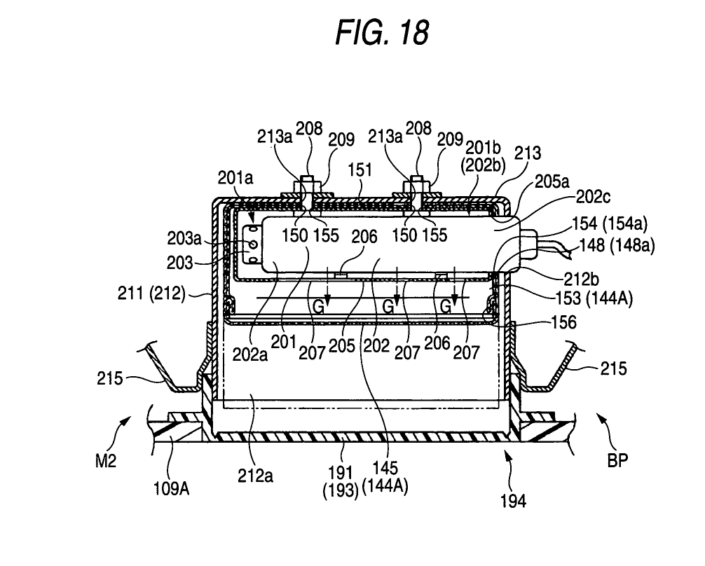

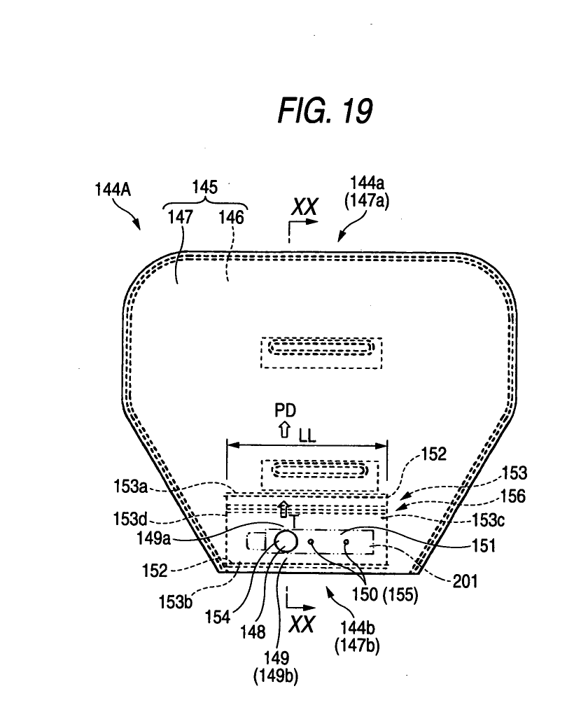

The airbag 144A is configured so that the outer shape of each of the driver-side wall portion 146 and the column-side wall portion (i.e., the vehicle-side wall portion) 147 of the airbag body 145 extends in an up-down direction, and that the lateral width dimension of the inflator 201 is tapered toward the bottom. Also, the insertion hole 148, into which the inflator 201 is inserted, in the airbag body 145 is provided slightly toward the right edge (see FIG. 18, and in the case illustrated in FIG. 19, the rear surface side and the left edge side) from the substantially center in the lateral direction at the side of the bottom of the column-side wall portion 147. Additionally, the attaching holes 150, 150, through each of which the bolt 208 of the diffuser 205 is passed, are provided in the left side (see FIG. 18, and in the case illustrated in FIG. 19, the rear surface side and the right edge side) of the insertion hole 148, so that the attaching part 151 is provided. Further, an airbag body 145 is configured so that the projecting end thereof at inflation is placed at the side of the top edge 144a (i.e., the top edge 147a of the column-side wall portion 147) of the airbag 144A. Further, the airbag 144A is configured so that the airbag body 145 is formed by two folding a piece of a cloth material which is obtained by connecting the driver-side wall portion 146 and the column-side wall portion 147 at a part of the periphery, and sewing the outer peripheries thereof. The airbag 144A differs from the airbag 144 according to the second embodiment in these respects. The remaining constituent elements including the seal cloth 153 are similar to the corresponding elements of the airbag 144 according to the second embodiment. Each part of the third embodiment, which is the same as the corresponding element of the second embodiment, is designated by the same reference numeral used to designate the corresponding element of the first element.

A fitting hole 154, in which a base end 201b (i.e., a base end 202b of the body 202) detached from a gas discharge port 203a at the side of a leading end 201a of the inflator 291 can be fit, is provided in the seal cloth 153 of the airbag 144A. Through holes 155, through each of which a bolt 208 of the diffuser 205 is passed, are provided in a left side part (see FIG. 18, and in the case illustrated in FIG. 19, a rear-surface-side and right-side-part) of the fitting hole 154. The fitting hole 154 is circularly opened to have an inside diameter dimension at which the base end 201b of the fit inflator 201 can be fit into the fitting hole 154 without no space between the base end 201a and an inner surface of the fitting hole 154.

Further, the seal cloth 153 is configured so that in a state in which the base end 201b of the inflator 201 is inserted (or fit) into the insertion hole 148 and the fitting hole 154, the bottom edge 153b of the periphery of the fitting hole 154 is attached to the top edge 149b, which is at a side in a direction opposite to the direction PD of action of the tensile force T of the airbag body 145, in the periphery 149 of the insertion hole 148 by sewing using suture threads 152. Additionally, the top edge 153a of the periphery of the fitting hole 154 is attached to the top edge 149a at the side in the direction PD of action in the periphery 149 of the insertion hole 148 by sewing. Further, at the generation of the tensile force T acting upon the periphery 149 of the insertion hole 148 at inflation of the airbag body 145, the top edge 153a and the bottom edge 153b are attached to the column-side wall portion 147 by sewing so as to provide a looseness 156 at the side of the top edge 153a, the bottom edge 153b can perform shift movement at ease integrally with the top edge 149a serving as a destination of movement in the periphery 149 of the insertion hole 148.

Incidentally, in the third embodiment, the lateral width dimension LL of the seal cloth 153 is set to be longer than a length dimension in an up-down direction of the seal cloth 153 expanded flat so that when the bottom edge 149b of the periphery 149 of the insertion hole 148 of the inflated airbag body 145 is moved, the left edge 153c and the right edge 153d are not convoluted. In the third embodiment, the left edge 153c and the right edge 153d of the seal cloth 153 are not attached to the column-side wall portion 147 by sewing, similarly to the second embodiment.

The inflator 201 is configured to have a cylindrical body 202, and a cylindrical head part 203 which is smaller in diameter than the body 202 and is provided at the rear end 201a of the inflator 201. The head part 203 is provided with a plurality of gas discharge ports 203a for discharging inflation gas. The inflator 201 is attached to the mounting part BP by providing the base end 202b of the body 202 at the positions of the inner peripheral surfaces 148a and 154a of the insertion hole 148 of the airbag body 145 and the fitting hole 154 of the seal cloth 153.

A bottomed cylindrical diffuser 205 made of metal sheet for regulating a direction, in which inflation gas flows out of the gas discharge port 203a, is provided around the inflator 201. The diffuser 205 is provided with a plurality of discharge ports 207 at the rear side thereof so as to cause the inflation gas G contained in the airbag 144A (i.e., the airbag body 145) to flow out to the top and bottom door parts 192 and 193 of a rear-side air bag cover 191. Further, the diffuser 205 has a plurality of sandwiching portions 206 which sandwich and hold the inflator 201. A plurality of bolts 208 for attaching the inflator 201 and the airbag 144A to the case 211 with a nut 209 are provided therein. Incidentally, the inflator 201 causes the base end 201b (202b) to protrude from a base-side insertion hole 205a of the diffuser 205 to the outside of the diffuser 205.

The case 211 is made of metal sheet and has a quadratic-prism-like peripheral wall portion 212 having a rectangular opening 212a in a rear end thereof, and also a bottom wall portion 213 closing the front end of the peripheral wall portion 212. Mounting holes 213a, through each of which each bolt 208 of the diffuser 205 penetrates, are formed in the bottom wall portion 213. An insertion hole 212b, into which the base end 201b of the inflator 201 is inserted, is formed in a right wall part of the peripheral wall portion 212. Also, a plurality of catching-pieces 214, each of which is inserted into each catching hole of each of attaching pieces, for catching the attaching pieces 195 are formed in upper and lower wall parts of the peripheral wall portion 212. Incidentally, attaching plates 215, each of which has a plurality of attaching brackets (not shown) protruding from surrounding-surfaces of the peripheral wall portion 212 and fixed to a vehicle body, are provided in the case 211. The airbag device M2 is mounted in and is fixed into a lower panel 109A of the mounting part BP.

The airbag cover 191 is provided to cover the rear side of the opening 212a of the case 211, and is configured to include a door portion 192, which is upwardly opened by being provided with a hinge portion 192a at the top edge side, and a door portion 193 which is downwardly opened by being provided with a hinge portion 193a at the bottom edge side. A thin breakably preformed H-shaped portion 194, as viewed from rear of the vehicle, is provided around each of the door portions 192 and 193. In a front-side of the airbag cover 191, a plurality of attaching pieces 195 frontwardly extending in the vicinity of periphery are provided. In each of the attaching pieces 195, a catching hole 195a for catching the periphery in the catching piece 214 is provided.

This airbag device M2 is mounted in a vehicle as follows. That is, the diffuser 205 is accommodated in the airbag 144A in a state in which the bolts 208 are outwardly protruded from the attaching port 150. Then, the airbag 144A is folded. Subsequently, the airbag is wrapped with a folding collapse preventing wrapping sheet.

Subsequently, the folded airbag 144A is accommodated in the case 211 while each bolt 208 is protruded from the associated attaching hole 213a. Further, the leading end 201a of the inflator 201 is inserted into the diffuser 205 through the insertion hole 212b of the case 211, the insertion hole 148 in the folded airbag 144A, and the fitting hole 154. Then, the sandwiching portion 206 is made to hold the inflator 201. Additionally, each of the bolts 208 is fastened with the nut 209. Subsequently, the attaching pieces 195 are caught by the catching pieces 214. Then, the airbag cover 191 is attached to the case 211. Thus, the airbag device M2 is assembled. Then, a lead wire extending from the airbag operating circuit is connected to the base end 201b of the inflator 201. Further, the case 211 is attached and fixed to the vehicle body, utilizing attaching brackets (not shown) of the attaching plates 215. Also, the lower panel 109A is assembled to a vehicle. Thus, the airbag device M2 can be mounted in the lower panel 109A serving as the mounting part BP.

Even in the airbag device M2 according to the third embodiment, when inflation gas G is discharged from a gas discharge port 203 at the side of the leading end 201a of the inflator 201, which is inserted in the airbag 144A, during operated, the airbag 144A protrudes form the mounting part BP and performs expansion/inflation while the airbag 144A push-opens the door portions 192 and 193 of the airbag cover 191. Thus, the airbag body 145 of the airbag body 145 completes the inflation.

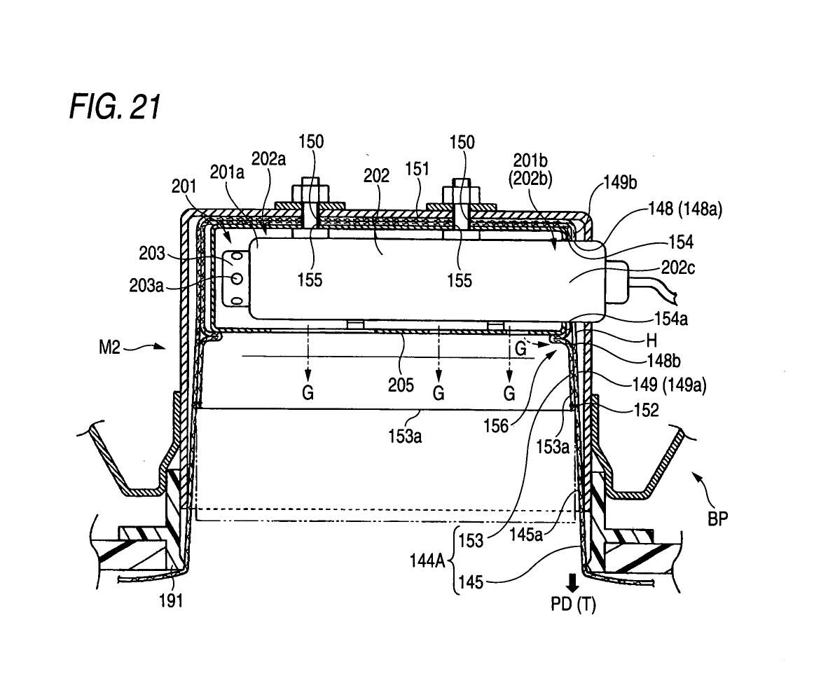

At that time, the position of the periphery 149 of the insertion hole 148 of the airbag body 145 is restricted by the base end 202b of the inflator 201 mounted in the mounting part BP, as illustrated in FIG. 21. Thus, the tensile force T acts in a direction in which the airbag 144A is protruded from the attaching part 151 to which the airbag body 145 is attached. A gap H is generated between the pull-side inner peripheral surface 148b at the side in a direction PD in which the tensile force T acts, and the outer peripheral surface 202 of the inflator 201 which are interposed by the insertion hole 148.

However, even in the third embodiment, the seal cloth 153 can perform relative shift movement with respect to the periphery 149 of the insertion hole 148 of the airbag body 145 while the looseness 156 is eliminated in a state in which the inflator 201 is fit into the fitting hole 154. Thus, the seal cloth 153 can cover the gap H between the outer peripheral surface 202c of the inflator 201 and the pull-side inner peripheral surface 148b. Consequently, the inflation gas G can be prevented from leaking outwardly from the airbag 144A through the insertion hole 148. Accordingly, the gas sealability of the periphery 149 of the insertion hole 148 in the airbag body 145 can be assured.

Therefore, even in the airbag device M2 according to the third embodiment, favorable gas sealability of the periphery 149 of the insertion hole 148, into which the inflator is inserted, and on which the tensile force T acts at expansion/inflation of the airbag 144A, can be obtained.

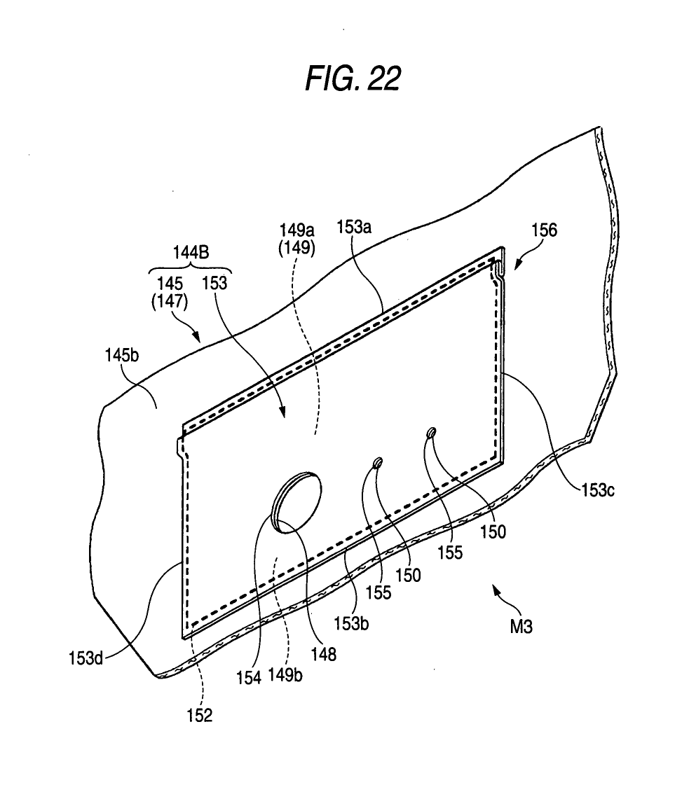

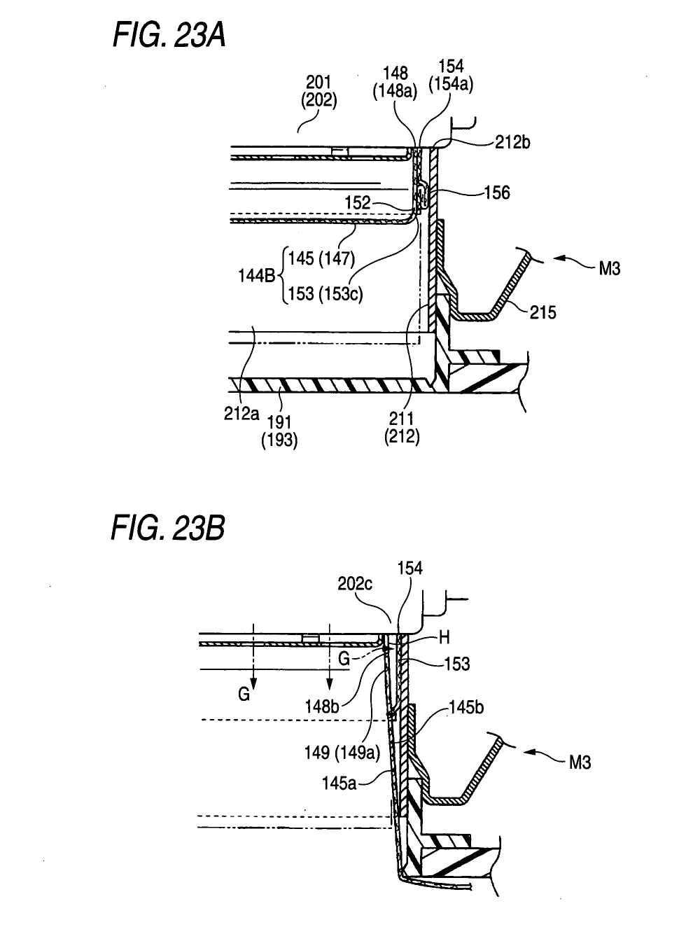

Incidentally, in the foregoing descriptions of the second and third embodiments, it has been described that the seal cloth 153 is provided on the inner peripheral surface 45a of the airbag body 145. Similarly to an airbag 144B of an airbag device M3 according to a fourth embodiment illustrated in FIGS. 22 to 23B, the seal cloth 153 can be placed on the outer peripheral surface 145b of the airbag body 145.

Even in the airbag device M3, when a gap H is generated between the outer peripheral surface 202c of the inflator 201 and the pull-side inner peripheral surface 148b during operated, the seal cloth 153 can cover the gap H on the outer peripheral surface side 145b of the airbag body 145. Consequently, leakage of inflation gas G can be prevented from occurring.

Incidentally, in a case where the seal cloth 153 is provided on the outer peripheral surface 145b of the airbag body 145, when the airbag device M3 is operated, the inflation gas G flows into a space between the airbag body 145 and the seal cloth 153 at the side of the outer peripheral surface 145b of the airbag body 145 through the insertion hole 148 of the airbag body 145. Then, the seal cloth 153 receives a pressure due to the inflation gas G in a direction in which the seal cloth 153 is detached from the airbag body 145. Thus, it is necessary that the looseness 156 enabling the relative shift movement with respect to the seal cloth 153 is assured, and that the entire outer peripheral edge including the top edge 153a, the bottom edge 153b, the left edge 153c, and the right edge 153d of the seal cloth 153 is attached to the airbag body 145 in consideration of attaching-strength by sewing (see FIG. 22).

On the other hand, in the second and third embodiments in which the seal cloth 153 is provided at the side of the inner peripheral surface 145a of the airbag body 145, at the inflation of the airbag body 145, as illustrated in FIG. 21, the seal cloth 153 is pushed by the pressure of the inflation gas G against the inner peripheral surface 145a of the airbag body 145. Thus, as compared with the case of providing the seal cloth 153 at the side of the outer peripheral surface 145b of the airbag body 145, the attaching strength can be reduced, so that the seal cloth 153 can easily be attached to the airbag body 145.

Also, in a case where the seal cloth 153 is provided at the side of the inner peripheral surface 145a of the airbag body 145, only the top edge 153a and the bottom edge 153b serving as both edges extending along the direction PD of action of the tensile force T generated in the periphery 149 of the insertion hole 148 at the inflation, which are intervened by the fitting hole 154, can be attached to the airbag body 145, similarly to the first and third embodiment. That is, in a case where the top edge 153a and the bottom edge 153b extending along the direction PD of action of the tensile force T in the seal cloth are attached to the airbag body 145, the looseness 156 is eliminated from the seal cloth 153 at the inflation of the airbag body 145. Thus, at the time of covering the gap H between the outer peripheral surface 162c or 202c of the inflator 161 or 201 and the pull-side inner peripheral surface 148b of the insertion hole 148, an edge portion at the side of the starting point of the shift movement of the seal cloth 153, that is, the edge portion opposite to the direction PD of action of the tensile force T in the periphery 149 of the insertion hole 148 (i.e., in the second embodiment, the top edge 153a of the seal cloth 153, and in the third embodiment, the bottom edge 153b of the seal cloth 153) and an edge portion at the side of a destination of the shift movement of the seal cloth 153, that is, the edge portion in the direction PD of action of the tensile force T in the periphery 149 of the insertion hole 148 (i.e., in the second embodiment, the bottom edge 153b of the seal cloth 153, and in the third embodiment, the top edge 153a of the seal cloth 153) are stably attached to the airbag body 145. Consequently, at the inflation of the airbag body 145, the seal cloth 153 can smoothly perform shift movement with respect to the periphery 149 of the insertion hole 148, upon which the tensile force T acts, without being convoluted. On the other hand, both edges, that is, the left edge 153c and the right edge 153 in a direction perpendicular to the direction of action of the tensile force on the periphery edge 149 of the insertion hole 148 in the seal cloth 153 are shifted away from the insertion hole 148. Thus, the seal cloth 153 does not perform shift movement to pass through the inner peripheral surface 145a of the airbag body 145. Additionally, the seal cloth 153 is placed at the side of the inner peripheral surface 145a of the airbag body 145, at inflation of the airbag body 145, a pressing force due to the pressure of the inflation gas G acts thereon. Unless the seal cloth 153 does not approach too close to the insertion hole 148 to enter the insertion hole 148, the seal cloth 153 is difficult to convolute. Consequently, in a case where the seal cloth 153 is provided at the side of the inner peripheral surface 145a of the airbag body 145, even when only the top edge 153a and the bottom edge 153b serving as both edges extending along the direction PD of action of the tensile force T upon the periphery 149 of the insertion hole 148 in the airbag body 145 are attached to the airbag body 145, the gas sealability can be assured. Consequently, attachment of the seal cloth 153 to the airbag body 145 is facilitated.

Incidentally, the attachment of the seal cloth 153 to the airbag body 145, which is other than the edge (i.e., in the second embodiment, the bottom edge 153b, and in the third embodiment, the top edge 153a) in the direction PD of action of the tensile force T in the periphery 149 of the insertion hole 148 at the side of a destination of shift movement, can be performed, simultaneously with attachment of the components of the airbag device (M2) to the mounting part (BP), similarly to the second and third embodiments, in addition to the utilization of sewing and bonding. That is, in the second embodiment, the top edge 153a of the seal cloth 153 is sandwiched, together with the top edge 149a of the periphery 149 of the insertion hole 148 in the column-side wall portion 147, by the ceiling wall 165b of the diffuser 165 and the ceiling wall 172 of the case 171. Thus, it is unnecessary to attach the top edge 153a of the seal cloth 153 directly to the column-side wall portion 147 of the airbag body 145 by sewing. Further, in the third embodiment, the bottom edge 153b of the seal cloth 153, together with the bottom edge 149b of the periphery 149 of the insertion hole 148 of the column-side wall portion 147, sandwiched by the diffuser 205 and the bottom wall portion 213 of the case 211. Thus, it is unnecessary to attach the bottom edge 153b of the seal cloth 153 directly to the column-side wall portion 147 of the airbag body 145 by sewing.

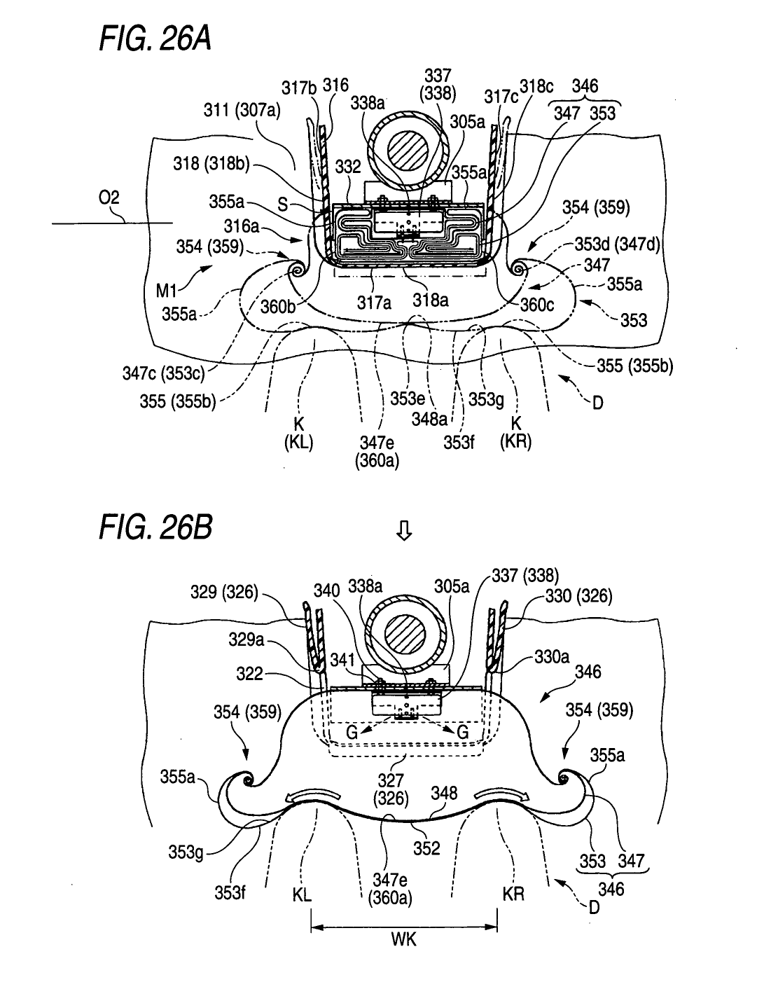

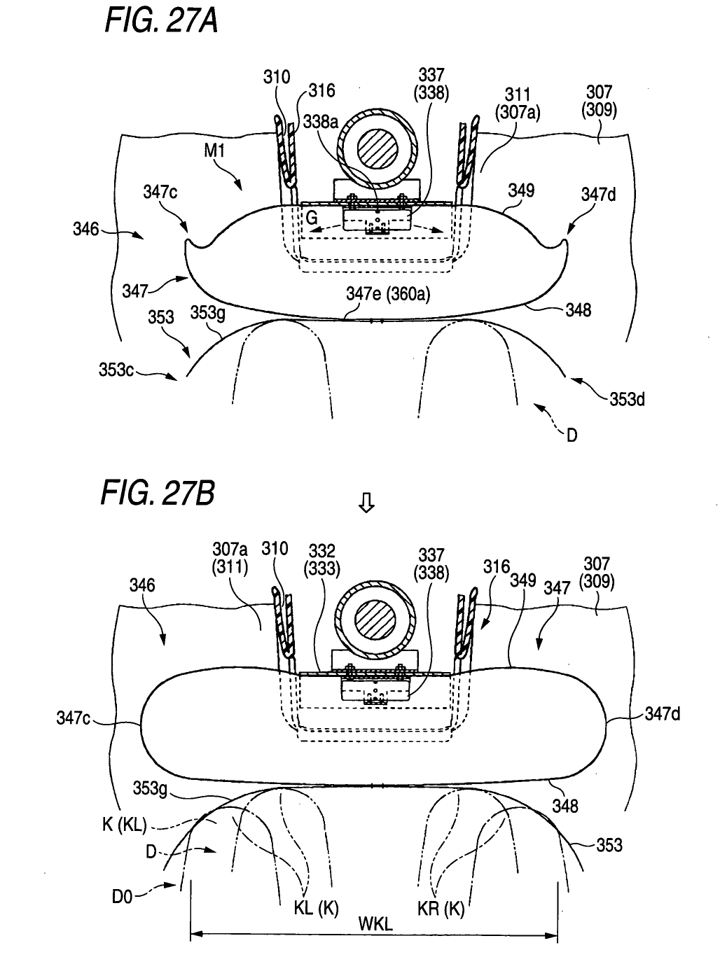

A knee-protecting airbag device M1 according to a fifth embodiment is of the steering-column-mount type to be attached to a steering column. As illustrated in FIGS. 26A and 26B, the knee-protecting airbag device M1 is configured by accommodating a folded airbag 346 in a lower part 316a of a column cover 316. The knee-protecting airbag device M1 is constructed by having a folded airbag 346, an inflator 337 for supplying inflation gas to the airbag 346, and a case 332 serving as an accommodation part for accommodating the airbag 346 and the inflator 337. The inflated airbag 346 push-opens a door portion 326 provided in the column cover 316 and is disposed in front of both knees K (a left knee KL, and a right knee KR) of a seated driver D (see FIG. 27) so as to be protruded downwardly or backwardly (more particularly, in an obliquely backward direction), that is, to the side of both the knees KL and KR of the driver D from the case 332.

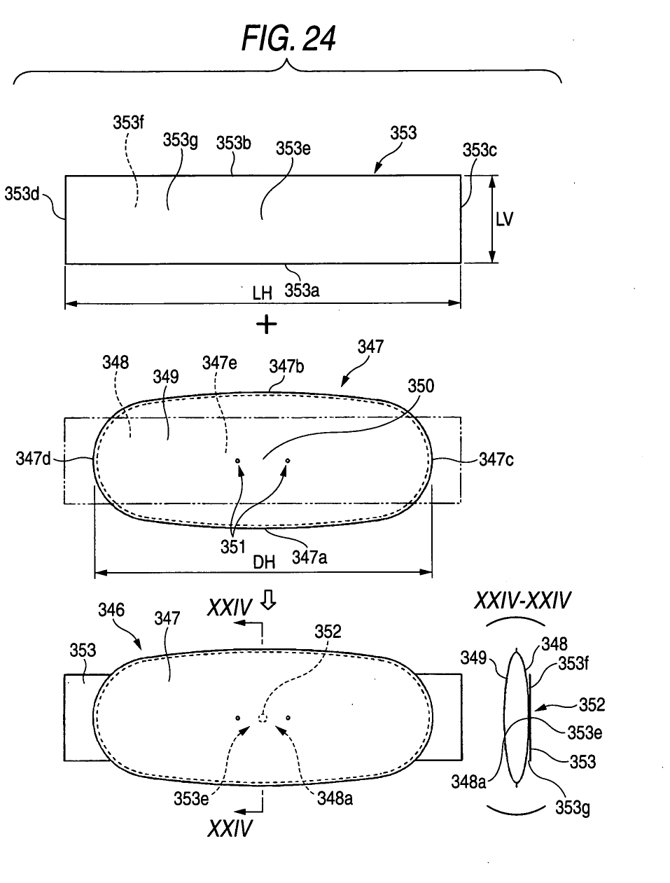

As illustrated in FIGS. 24 to 27B, the column cover 316 covers a steering column protruding backwardly from an instrument panel 307 and is shaped into a substantially quadrangularly cylinder, and is made of a synthetic resin. The column cover 316 is attached to a column tube of the steering column at a part (not shown) thereof, and protrudes backwardly from an accommodation opening 310 of the instrument panel 307. Additionally, the column cover 316 is inclined and provided in front of the seated driver D so that a front end of the column cover 316 is downwardly arranged along an axial direction, and that a rear end thereof is upwardly placed. Incidentally, the steering column is configured to have a main shaft and the column tube disposed therearound. A steering wheel is connected to the main shaft. The instrument panel 307 includes an upper-side upper panel and a lower-side lower panel 309.

As illustrated in FIGS. 26A and 26B, a door portion 326 to be opened by being pressed by the airbag 346, is provided in the column cover 316 so that the single projection opening 322, from which the airbag 346 protrudes, can be formed in an area extending from the bottom surface 318a of an outer peripheral surface 318 to each of the a left-side surface 318b and a right-side surface 318c. The door portion 326 includes a lower front door part 327 and a lower rear door part placed at the side of the bottom surface 317a of a peripheral wall 317 of the column cover 316, a left door part 329 placed at the side of the left-side surface 317b of the peripheral wall 317, and a right door part 330 placed at the side of the right-side surface 317c of the peripheral wall 317 (see FIG. 26). The lower front door part 329 is configured to frontwardly open by employing the hinge part 327a at the front edge side as the center of rotation. The lower rear door part 329 is configured to rearwardly open by employing the hinge part 328a at the rear edge side as the center of rotation. The left door part 329 and the right door part 330 are configured to upwardly open by employing the hinge parts 329a and 330a placed at the top edge side as the centers of rotation. A breakably preformed part 324, which is so thin that can be broken by being pressed by the inflated airbag 347, is formed around each of the lower front door part 327, the lower rear door part 328, the left door part 329 and the right door part 330, other than the hinge parts 327a, 328a, 329a, and 330a respectively constituted by integral hinges.

Side walls 319 and 320, which extend upwardly from a bottom wall 317a, are respectively formed on the front and rear edges of the area, in which the projection opening 322 is formed, in the column cover 316. The side walls 319 and 320, together with the case 332, define and determine the accommodation space S which accommodates the folded airbag 346 and the inflator 337, in the column cover 316. Also, each of the side walls 319 and 320 serves as a mounting wall of the case 332, which will be described later. A plurality of catching-holes 319a and 320a, into which catching-pieces 334a and 335a of the case 332 are respectively inserted.

Incidentally, the accommodation space S, which accommodates the folded airbag 346 and the inflator 337, in the column cover 316 is constituted so that each of both the left and right sides of the accommodation space S is surrounded by the left door part 329, and the right door part 330, that each of both front and rear sides of the accommodation space S is surrounded by the side walls 334 and 335 of the case 332, that the top side of the accommodation space S is surrounded by a ceiling wall 337 of the case 336, that the top side of the accommodation space S is surrounded by the ceiling wall 333 of the case 332, and that the bottom side of the accommodation space S is surrounded by the lower front door part 327 and the lower rear door part 328.

The case 336 is cross-sectionally inverse-U-shaped and is made of sheet metal. The case 332 is configured to have a ceiling wall 333 and side walls 334 and 335 extending downwardly from the front and rear edges of the ceiling wall 333. A plurality of cross-sectionally J-shaped catching pieces 334a and 335a, which are respectively inserted into the catching holes 319a and 320a provided in the side walls 319 and 320 of the column cover 316 and connected to the side walls 319 and 320, are formed in the side walls 334 and 335, respectively. A plurality (e.g., two in the fifth embodiment) of through-holes 333a to be respectively passed through bolts 340 are formed in the ceiling wall 333.

The case 332 constitutes the top side of the accommodation part which accommodates and holds the inflator 337 and the airbag 346. The case 332 is attached and fixed to the column tube of the steering column. This case 332 is formed to have a lateral width dimension which is narrower than the separation distance WK (see FIG. 26B) between both left and right knees KL and KR of the driver D. In the fifth embodiment, the case 332 is placed in an area in front of the center of both the knees KL and KR (see FIGS. 26A and 26B). Further, the case 332 is attached and fixed to a bracket 305a of the column tube by fastening the mounting bolts 340 of the inflator 337, which are used to attach and fix the airbag 346 to the case 332, with the nut 341.

The inflator 337 includes a cylindrical body 338 of the cylinder type having a plurality of gas discharge ports 338a, from which inflation gas is discharged, and a retainer 339 made of sheet metal used to hold the body 338 and to attach and fix the airbag 346 to the case 332. The body 338 is configured so that when the airbag device is mounted in a vehicle, the plural gas discharge ports 338a are disposed in a central portion in a lateral direction of the body 338 by setting an axial direction O2 (see FIG. 26A) to extend along the lateral direction. The retainer 339 is substantially cylindrically-shaped so that an axial direction of the retainer, which extends along the lateral direction that coincides with the axial direction O2 of the body 338. The retainer 343 has the plural bolts 340 (two bolts in the fifth embodiment) which upwardly extend and are provided side by side along the lateral direction. Openings 339a for flowing inflation gas, which is discharged from the gas discharge ports 338a, to lateral external spaces are respectively formed in both lateral ends of the retainer 339, a bottom surface side of each of which is formed as a halved cylinder by being partly cut away. Also, a sandwiching portion 339b, which is reduced in diameter, is formed in the proximity of a center in the lateral direction of the retainer 339 so as to be able to hold the body 338 when inserted thereinto.

Incidentally, in the fifth embodiment, the bolts 340 of the retainer 339 constitute the mounting means for mounting the inflator 337 in the case 332, as having already been described. Also, the bolts 340 serve to fasten the inflator 337 and the airbag body 347 together to the case 332, and also serve to attach the case 332 itself to the bracket 305a of the column tube of the steering column by being fastened thereto with a nut 341.

As illustrated in FIG. 24, the airbag 346 includes the airbag body 347 and a slip cloth 353. The airbag body 347 has an occupant-side wall portion 348 placed at the side of the driver (or occupant) D at completion of inflation of the airbag, and a vehicle-body-side wall portion 349 placed at the side of the column cover 316 of a vehicle body (see FIG. 27). At the completion of inflation thereof, the airbag body 347 is shaped like a substantially rectangle plate so that the lateral length of the shape is longer than the anteroposterior length thereof. The driver-side wall portion 348 and the column-side wall portion 349 are made of flexible woven cloth including polyester and polyamide. The airbag 347 of the flat surface airbag type is formed by cutting the woven cloth so that the driver-side wall portion 349 and the column-side wall portion 350 have the substantially rectangular outer shape extending in the lateral direction, and by also sewing the peripheries of these portions. Thus, a flat-surface airbag type airbag body 347 is formed.

Additionally, as illustrated in FIG. 24, in the vehicle-body-sidewall portion 349 of the airbag body 347, two mounting holes 351, through each of which the bolts 340 of the inflator 337 is passed, are provided in the proximity of the center in anteroposterior direction and in a lateral direction side by side along the lateral direction. Further, in the fifth embodiment, the airbag 347 is attached to the case 332 and to the column tube, utilizing the inflator 337. Accordingly, a region, in which the inflator 337 is disposed, around each of the mounting holes 351, 351 is sandwiched by the ceiling wall 333 of the case 332 and the retainer 339 of the inflator 337 when each of the bolts 340 is fastened with the nut 341. Thus, in the fifth embodiment, the mounting portion 350 is a substantially rectangular area, which laterally extends, at the center in the anteroposterior direction and the lateral direction of the vehicle-body-side wall portion 349 according to the outer shape of the inflator 337.

Incidentally, the airbag body 347 is provided with a tether therein, which connects a vehicle-body-side wall portion 349 and an occupant-side wall portion 348 to each other and regulates the thickness at inflation thereof and which can maintain a substantially rectangular plate shape at completion of the inflation.

Apparently, this airbag body 347 is configured to assure anteroposterior and lateral dimensions at which the airbag body can cover the bottom surface 318a of the column cover 316 backwardly protruding from the instrument panel 307 toward the left knee KL and the right knee KR of the driver D and a rear surface 307a serving as the bottom edge side periphery 311 of the accommodation opening 310 in the instrument panel 307 (see FIGS. 27A and 27B) at the completion of expansion/inflation thereof.

Although the airbag body 347 is constituted by two separate pieces of cloth materials, which are the occupant-side wall portion 348 and the vehicle-body-sidewall portion 349, in the fifth embodiment, the airbag body 347, the airbag body 347 can be formed by two folding a single cloth material obtained by connecting parts of anteroposterior peripheral edges of two pieces of cloth materials and by sewing an outer periphery thereof.

As illustrated in FIG. 24, a slip cloth 353 is formed like a flexible belt extending laterally, which is placed on a surface of the airbag body 347 at the expansion/inflation, which is at the side of the driver D (i.e., at the side of the occupant-side wall portion 348). The slip cloth 353 is such that the lateral length dimension LH of the slip cloth expanded flat is longer than the separation distance WK between both left and right knees KL and KR of the driver D and is equal to or longer than the lateral length dimension DH of the airbag body expanded flat. In the fifth embodiment, the length dimension LH is set to be longer than the length dimension DH. That is, the length dimension LH is set at a length dimension by which the left edge 347c or the right edge 347d of the slip cloth 353 protrudes from the left edge 347c or the right edge 347d in the lateral direction of the airbag body 347 expanded flat. An anteroposterior length dimension LV of the slip cloth is assured so that the slip cloth can cover a region extending in an up-down direction along both the keens KL and KR of the driver D. In the fifth embodiment, the slip cloth 353 has a length dimension so that the front edge 353a and the rear edge 353b of the slip cloth are placed within a region between the front edge 347a and the rear edge 347b in the anteroposterior direction of the airbag body 347 expanded flat.

Additionally, the slip cloth 353 is formed of flexible woven cloth including polyester and polyamide, similarly to the airbag body 347. Incidentally, the slip cloth 353 can be configured by employing a cloth material whose sliding ability is higher than the occupant-side wall portion 348 itself so that the rear surface 353g of the slip cloth 353, which is at the side of the occupant-side wall portion 348, can favorably slide on the airbag body 347 expanded flat. Alternatively, lubricant can be applied to the slip cloth 353. A cloth material enabled to suppress increase in weight and to prevent occurrence of slippage can be used as the material of a surface 53f of the slip cloth 353, which is at the side of both the left and right knees KL and KR, so as to be able to stably support the airbag body when being in contact with both the left and right knees KL and KR. Alternatively, a slippage preventing material can be applied to the slip cloth 353.

Further, the slip cloth 353 is provided, as illustrated in FIGS. 26A and 26B. That is, at the expansion/inflation of the airbag 346, the front surface 353f (i.e., the bottom surface) of the slip cloth 353, which is at the occupant-side (i.e., the side of the bottom surface 347e in the fifth embodiment) of the air bag body 347 protruding from the case 332 serving as the accommodation part, is applied to both the left and right knees KL and KR of the driver D so as to close the space between both the left and right knees KL and KR. Also, the airbag body 347 is made to slide on the rear surface 353g (i.e., the top surface in the fifth embodiment) of the slip cloth 353 so that the expansion of the airbag body 347 to both lateral sides can be guided. In the fifth embodiment, the slip cloth 353 is provided with looseness parts 355a, 355a, which are folded and formed only of the slip cloth 353, so as to reduce the lateral length thereof. The slip cloth 353 covers at least the left-side surface 360b and the right-side surface 360c at both the left and right sides from an occupant-side surface (i.e., the bottom surface) of the folded airbag body 347. The slip cloth 353 is accommodated, together with the airbag body 347, in the case 332 serving as the accommodation part.

More particularly, in the fifth embodiment, a central part 353e in the lateral direction of the slip cloth 353 is connected to a central part 348a in the anteroposterior direction of the occupant-side wall portion 348 of the airbag body 347 by sewing or bonding. Also, a part (i.e., a convolution part) 354 of the slip cloth 353 is folded integrally with the airbag body 347. The remaining part (i.e., a protruded part 355) is provided to surround at least the lateral outer peripheral surface of the airbag body 347 other than the vicinity of the attaching part 350. In the fifth embodiment, the slip cloth 353 is connected to the airbag body 347 by sewing using suture threads 352.

An operation of folding the airbag 346 in the fifth embodiment is described below. Incidentally, each of the bolts 340 is preliminarily protruded from the attaching hole 351 of the vehicle-body-side wall portion 349 before folding the airbag 346, and the inflator 337 is accommodated in the airbag 346 in the process of manufacturing the airbag body 347. Then, the folding of the airbag 346 is performed in a state in which the inflator 337 is accommodated therein.

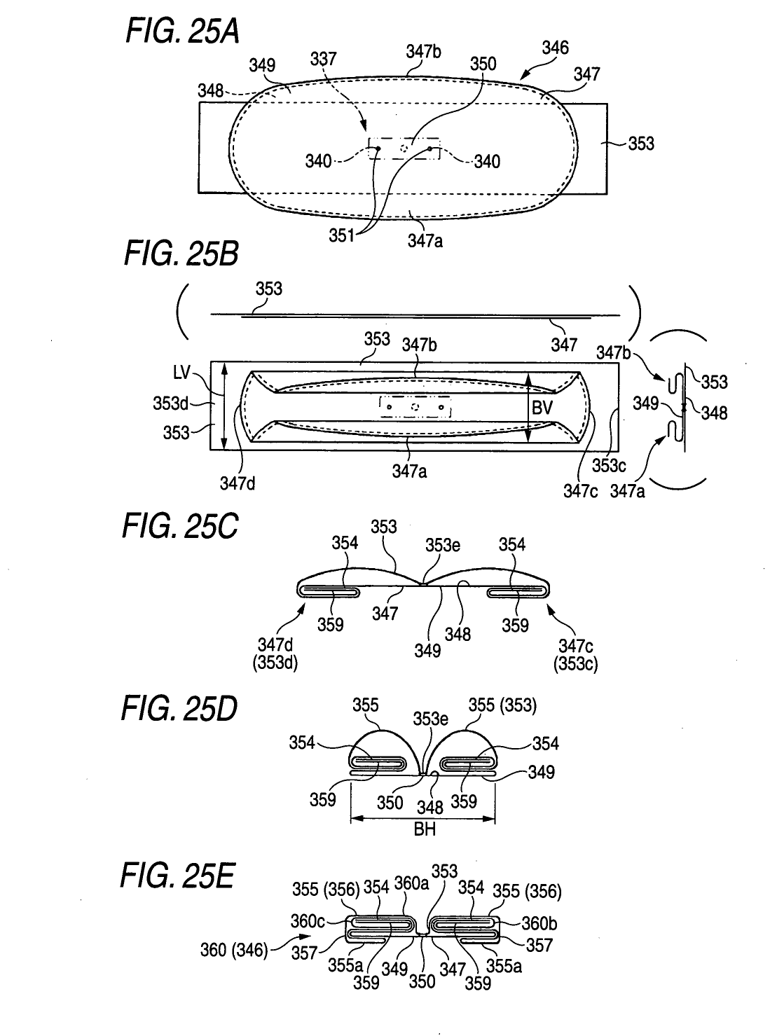

In the fifth embodiment, first, as illustrated in FIG. 25A, the vehicle-body-side wall 349 and the occupant-side wall portion 348 of the airbag body 347 are expanded flat, together with the slip cloth 353, and are overlapped with one another. Subsequently, as illustrated in FIG. 25B, the airbag 346 is folded so as to make the front edge 347a and the rear edge 347b of the airbag body 347 closer to the center in the anteroposterior direction so that a width dimension BV in the anteroposterior direction of the airbag 346 (i.e., the airbag body 347) is made to correspond to the width dimension in the anteroposterior direction of the accommodation space S (i.e., the case 332) (or so that the dimension is set at a value at which the airbag 346 is accommodatable in the accommodation space S). In the fifth embodiment, the front edge 347a and the rear edge 347b are accordion-folded at the side of the vehicle-body-side wall portion 349. The anteroposterior width dimension BV at that time is set to be shorter than the anteroposterior length dimension LV of the slip cloth 353.

Subsequently, as illustrated in FIGS. 25B to 25E, the airbag 346 (i.e., the airbag body 347) is folded so as to make the lateral width dimension BH correspond to the lateral width dimension of the accommodation space S (i.e., so as to set the dimension BH at a value at which the airbag 346 is accommodatable in the accommodation space S) by making the front edge 347a and the rear edge 347b of the airbag body 347 closer to the center in the lateral direction. In the fifth embodiment, first, as illustrated in FIGS. 25B and 25C, both the lateral edges, that is, the left edge 353c and the right edge 353d of the slip cloth 353 are overlapped with the associated lateral edges, that is, the left edge 347c and the right edge 347d of the airbag body 347 at the side of the occupant-side wall portion 348, respectively. Then, the slip cloth 353 overlapped with the airbag body 347 are integrally roll-folded at each of both lateral sides to be convoluted to the vehicle-body-side wall portion 349, so that the roll-folded parts 359 are formed. A part of each of the left edge 353c and the right edge 353d of the slip cloth 353 is convoluted to an associated one of the folded parts 359, so that the convolution parts 354 respectively convoluted to the folded parts 359 are formed in the slip cloth 353.

Subsequently, as illustrated in FIGS. 25C and 25D, the left and right folded parts 359, 359 are placed on the occupant-side wall part 348. At that time, in the slip cloth 353, a part extending toward the central part 353e from each of the convolution parts convoluted in the folded parts 359 is protruded from an associated one of the folded parts 359, so that protrusion parts 355, 355 are formed at both lateral sides of the central part 353e.

As illustrated in FIGS. 25D and 25E, the protrusion parts 355 are formed by pulling the cloth toward the attaching part 350 of the vehicle-body-side wall portion 349 from the occupant-side wall portion 348 of the airbag body 347 to convolute the cloth. A bottom surface covering part 356 and a side surface covering part 357 of the protrusion part 355 of the slip cloth 353 are convoluted onto a folding completion body 360 to extend from a surface 360a (i.e., a bottom surface in a vehicle-mounted state) at the side of the driver (or occupant) D of the folding completion body 360 of the airbag body 347 to a left-side surface 360b and a right-side surface 360c. Thus, the folding of the airbag 346 is completed. At that time, only the slip cloth 353 is accordion-folded on each of the left and right protrusion parts 355, 355 on each of which a looseness part 355a extending to the proximity of the attaching part of the vehicle-body-side wall portion 349 is formed. Incidentally, the front edge 353a and the rear edge 353b of the slip cloth 353 are provided to be bent to cover the front surface 360d and the rear surface 360e placed at anteroposterior positions of the surface 360a at the side of the driver D of the folding completion body 360.

Upon completion of folding the airbag 346, the airbag 346 is wrapped with a folding-collapse preventing wrapping member (not shown) so as to prevent occurrence of the folding-collapse. Subsequently, the folded airbag 346 and the inflator 337 are accommodated in a space between the side walls 334 and 335 of the case 332 provided on the bottom surface of the ceiling wall 333 while each of the bolts 340 of the inflator 337 is passed through an associated one of the through holes 333a. Then, a spring nut (not shown) is attached to each of the bolts 340. The airbag 346 and the inflator 337 are assembled to the case 332. Thus, an airbag assembly is formed.

Then, the assembled airbag assembly is attached and fixed to the bracket 305a of the column tube of the steering column by fastening each of the bolts 340 with the nut 341. A lead wire (not shown) extending from an airbag operating circuit is connected to the body 338 of the inflator 337. Then, the column cover 316 is attached to the steering column while catching pieces 334a and 335a are caught in the side walls 319 and 320 by inserting catching pieces 334a and 335a into catching holes 319a and 320a, respectively. Thus, the knee-protecting airbag device M1 can be mounted in a vehicle.

When the knee-protecting airbag device M1 according to the fifth embodiment is operated after mounted in the vehicle, the body 338 of the inflator 337 discharges inflation gas G from gas discharge ports 338a. The inflation gas G is supplied from the openings 339a provided in both lateral ends of the retainer 339 to the airbag body 347 of the airbag 346. Then, when the inflation gas G is supplied to the airbag body 347, the airbag body 347 push-opens the lower front door part 327, the lower rear door part 328, the left door part 329, and the right door part 330 of the door portion 326. The airbag body 347 protrudes downwardly from the opened projection opening 322 to perform expansion and inflation.

At that time, even when the airbag body 347 enters a space between both the left and right knees KL and KR while touching both the left and right knees KL and KR of the driver D, before widely expanded to both lateral sides, as illustrated in FIGS. 26A and 26B, the slip cloth 353 covers at least the left-side surface 360b and the right-side surface 360c at both the lateral sides from the surface 360a at the side of the driver D of the folded airbag body 347 when the airbag body 347 is folded and accommodated. While quickly spreading the looseness parts 355a, 355a, at the side of the driver D of the airbag body 347, the surface 353f of the slip cloth 353 is applied to both the left and right knees KL and KR of the driver D to close the space between the left and right knees KL and KR. Then, as illustrated in FIGS. 26B and 27A, the airbag body 347 is caused to slide on the rear surface 353g of the slip cloth 353 to guide the expansion of the airbag body 347 in the lateral direction. Thus, the airbag body 347 is expanded and inflated in both the lateral directions, without entering the space between the left and right knees KL and KR of the driver D, to face both the left and right knees KL and KR (see FIG. 27B).

Accordingly, in the knee-protecting airbag device M1 according to the fifth embodiment, even when the airbag 346 is brought into contact with both the left and right knees KL and KR of the driver D in an initial stage of the expansion/inflation, the airbag 346 is contacted directly and only with the knees, the slip cloth 353 closes the space between both the left and right knees KL and KR while touching both the knees KL and KR. Thus, the airbag body 347 completes the expansion toward both the left and right sides without unfolding both the left and right knees KL and KR. Consequently, the airbag body 347 can assure the cushioning action and can catch both the left and right knees KL and KR which smoothly and frontwardly move.

Incidentally, as illustrated in FIG. 27B, the airbag body 347 can expand and inflate toward both lateral sides to face both left and right knees KL and KR (see dot-and-dash lines in this figure) of a driver D0, who is not close to and is seated sufficiently apart from the column cover 316, in a state, in which the airbag body 347 faces both the left and right knees KL and KR of the driver D0, and in which the airbag body 347 is in neither direct contact nor indirect contact through the slip cloth 353 with both the left and right knees KL and KR.

In the fifth embodiment, in a state in which the occupant-side wall portion 348 of the airbag body 347 is overlapped with both of the associated both left edges 353c and 347c and both the associated right edges 353d and 347d of the slip cloth 353, the convolution part 354, into which only a part of each of both the left edge 353c and the right edge 353d of the slip cloth 353 is convoluted, is formed in the associated folded part 359 in which the slip cloth 353 is folded to be close to the center in the lateral direction of both the left edge 353c and the right edge 353d of the airbag body 347. Then, each of the convolution parts 359 is accommodated, together with the airbag body 347, in the case 332 (see FIG. 25).

Thus, both the left edge 353c and the right edge 353d of the slip cloth 353 are put into a state, in which these edges are held in the folded part 359 of the airbag body 347, by utilizing the convolution part 354. In an initial stage of the inflation of the airbag body 347, each of contact parts 355b, 355b (see FIG. 26A) of the slip cloth 353, which is contacted with both the left and right knees KL and KR of the driver D, can stabilize a movement locus. The contact parts 355b, 355b can appropriately be contacted with both the left and right knees KL and KR of the driver or occupant D and also can be supported by both the left and right knees KL and KR. Thus, the airbag body 347 can surely be expanded and guided on the rear surface side 353g of the slip cloth 353. Additionally, the slip cloth 353 is provided with looseness parts 355a, 355a so as to only convolute the convolution parts 354, 354, each of which is provided at each of both lateral sides of the slip cloth 353, into the folded parts 359, 359 of the airbag body 347. Thus, relative movement at expansion in a lateral direction of the airbag body 347 is performed by causing the airbag body 347 to slip on the rear side surface 353g of the slip cloth 353 and can freely be achieved for a margin of a length of the looseness part 355a without being regulated.

In a case where the space between both the left and right knees KL and KR of the driver D can be closed by applying the front surface 353f of the slip cloth 353 to both the left and right knees KL and KR of the driver D at the occupant-side of the airbag body 347 protruding from the case 332 serving as the accommodation part at the expansion/inflation of the airbag 346, the lateral length dimension LH of the slip cloth 353 expanded flat can be set at a value which is equal to or more than the lateral width dimension WKL (see FIG. 27B) at which at least both the left and right knees KL and KR of the seated driver D can sufficiently be covered from the front side, and which is slightly shorter than the lateral length dimension DH of the airbag body 347 expanded flat. That is, the airbag body 347 itself assures the lateral length dimension at which both the left and right knees KL and KR of the driver D or D0 can be protected in a state in which the expansion/inflation thereof is completed. The lateral length dimension DH of the airbag body 347 put into a state, in which the airbag body 347 expanded flat in a non-inflation condition, is longer than the lateral length dimension of the inflated airbag body 347. Furthermore, in a case where the lateral length dimension LH of the slip cloth 353 expanded flat is set to be equal to or more than a value slightly less than the lateral length dimension DH of the airbag body 347 expanded flat, the device can assure a state in which the slip cloth 353 is surely applied to both the left and right knees of the driver D at the expansion/inflation of the airbag 346.

Also, in a case where the airbag body 347 can be guided in the process of the expansion, the slip cloth 353 may be unnecessary upon completion of the inflation. Therefore, the slip cloth 353 is not necessarily connected to the airbag body 347.

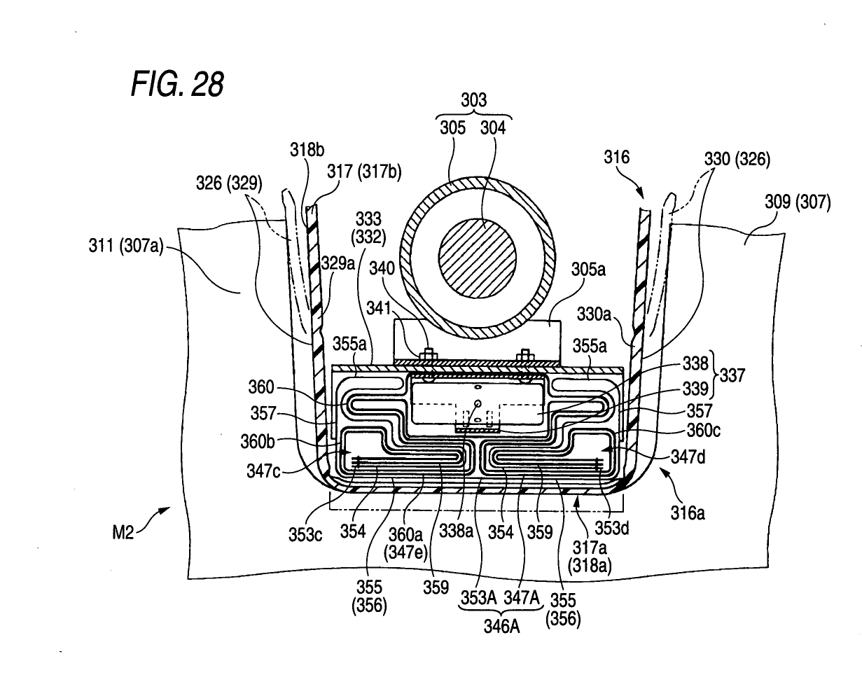

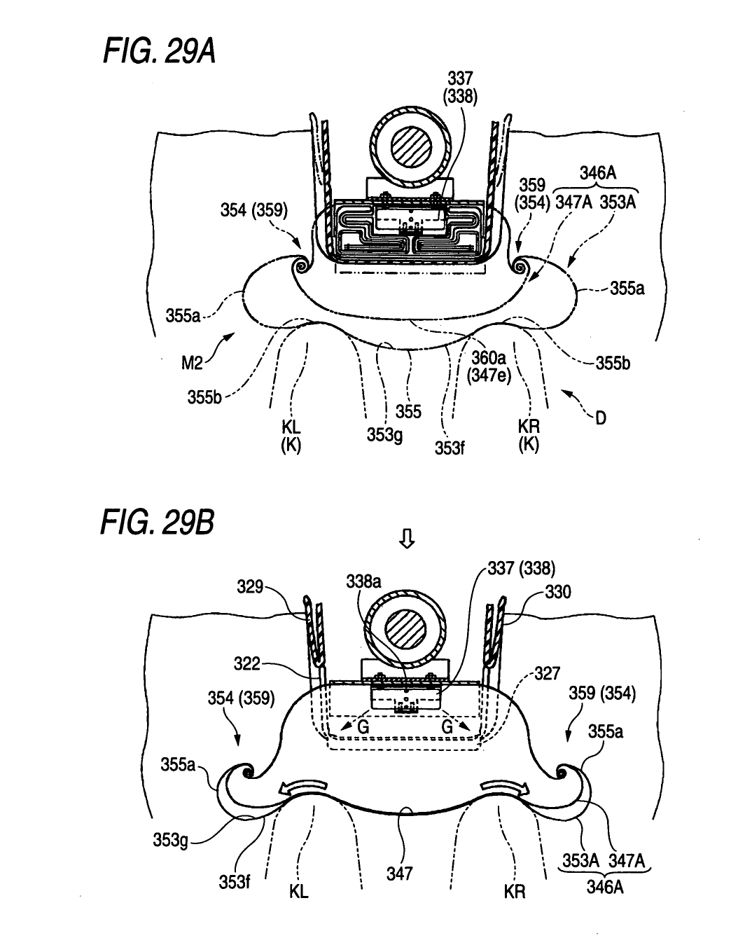

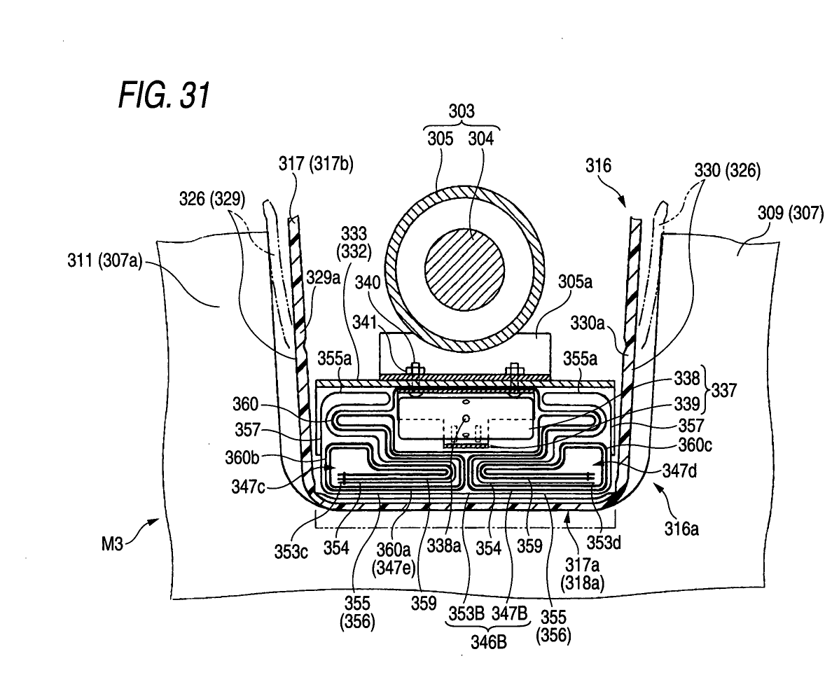

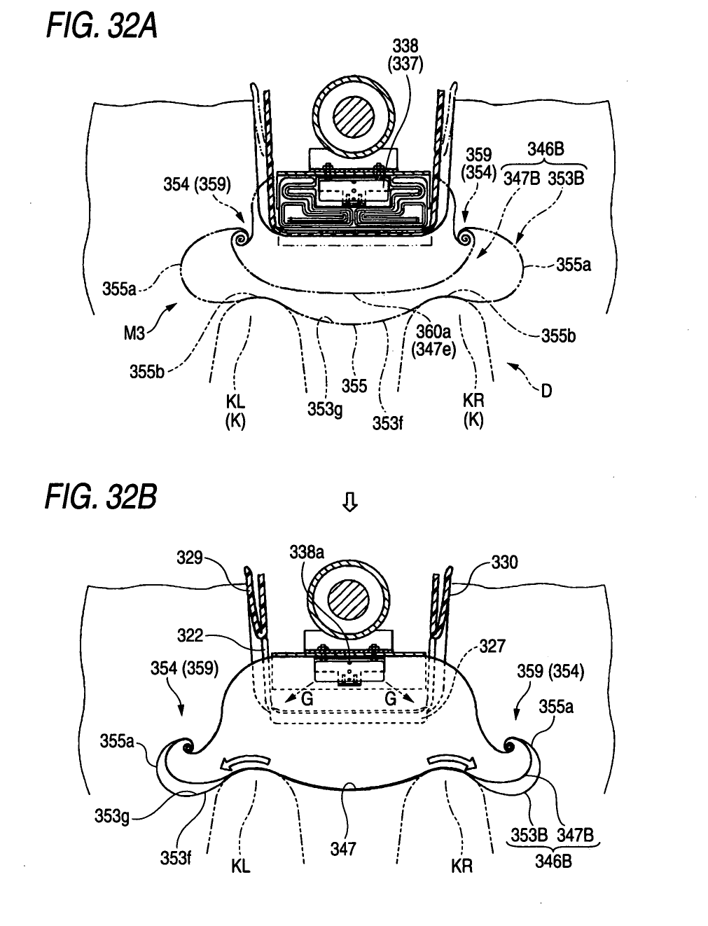

Incidentally, in a case where the central part 353e in the lateral direction of the slip cloth 353 is connected to the central part 348a in the lateral direction of the occupant-side wall portion 348 of the airbag body 347, as described in the description of the fifth embodiment, or where at least one of the left edge 353c and the right edge 353d in the lateral direction of the slip cloths 353A and 353B is connected to an associated one of the left edge 347c and the right edge 347d in the lateral direction of the airbag bodies 347A and 347B to thereby connect the slip cloth 353, 353A, or 353B to a part of the airbag body 347, 347A, or 347B, as described in the description of each of the airbag 346A of the knee-protecting airbag device M2 according to the sixth embodiment illustrated in FIGS. 28 to 30B and the airbag 346B of the knee-protecting airbag device M3 according to the seventh embodiment illustrated in FIGS. 31 to 33B, a fear of removal of the slip cloth 353 from the side of the driver D of the airbag body 347, 347A, or 347B in the process of the expansion of the airbag body 347, 347A, or 347B is eliminated. More stable expansion of the airbag body 347, 347A, or 347B in a lateral direction can be assured. Also, fibers of the slip cloth 353, 353A, or 353B can be prevented from flying apart to the driver D.

Also, in a case where the central part 353e in the lateral direction of the slip cloth 353 is connected to the central part 348e in the lateral direction of the occupant-side wall portion 348 of the airbag body 347, as described in the description of the fifth embodiment, the expansion of the airbag body 347 in the lateral direction is quickly performed in a balanced manner without resistance due to the slip cloth 353, as illustrated in FIGS. 26B and 27A, when the folding in both the left edge 347c and the right edge 347d of the airbag body 347 is not unfolded, because both the left edge 353c and the right edge 353d of the slip cloth 353 are not connected to the airbag body 347.

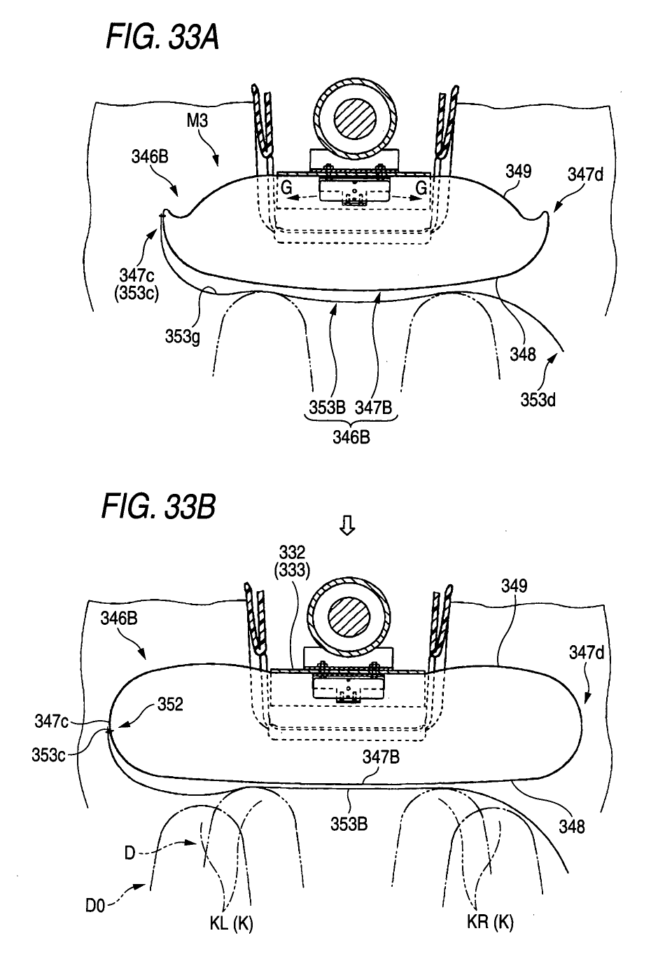

On the other hand, in a case where at least one of the lateral edges of the slip cloth 353B, that is, the left edge 353c is connected to the left edge 347c in the lateral direction of the associated airbag body 347B, similarly to the airbag 346B of the seventh embodiment illustrated in FIGS. 31 to 33B, the slip cloth 353B can surely be placed at the side of the driver D of the airbag body 347B in the vicinity of the left edge 347c connected to the slip cloth 353B of the airbag body 347B at the expansion/inflation of the airbag 346B, until the completion of the expansion, though the airbag body 347B is subjected to the resistance due to the slip cloth 353B, as illustrated in FIGS. 33A and 33B. The expansion of the airbag body 347B can smoothly be guided by the rear surface 353g of the slip cloth 353B over the entire region from the vicinity of the central part 348a to the left edge 347c in the lateral direction, which is connected to the slip cloth 353B.

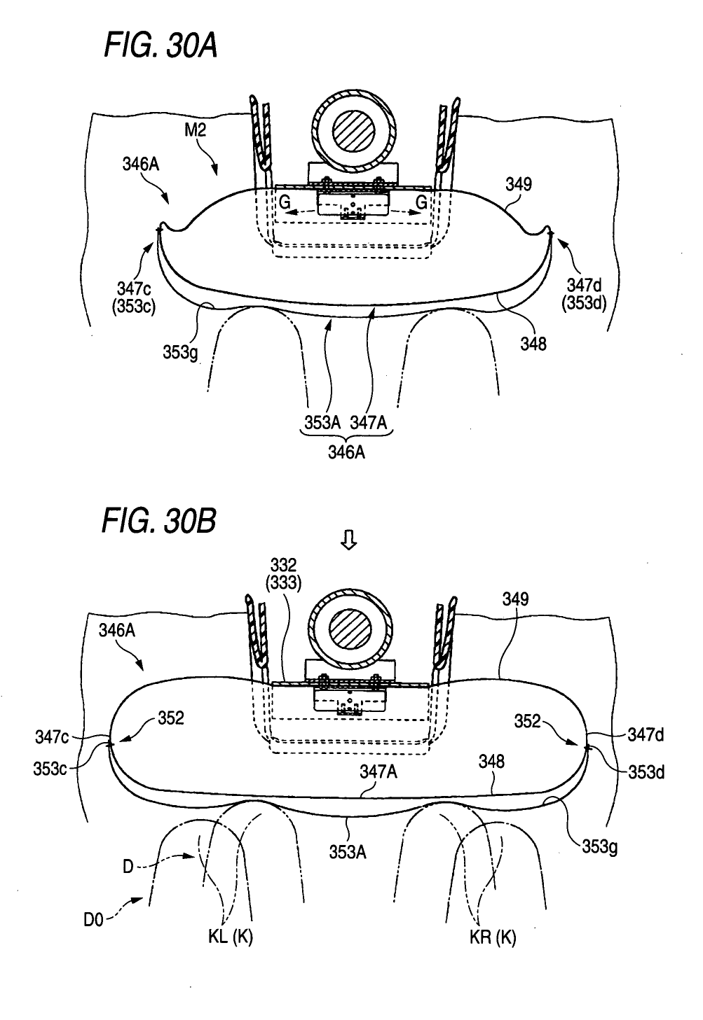

Apparently, in a case where both the lateral edges, that is, the left edge 353c and the right edge 353d of the slip cloth 353A are connected to the left edge 347c and the right edge 347d of the associated airbag body 347A, similarly to the airbag 346A of the knee-protecting airbag device M2 according to a sixth embodiment illustrated in FIGS. 28 to 30B, the slip cloth 353A can surely be placed at the side of the driver D of the airbag body 347A in the vicinity of the left edge 347c connected to the slip cloth 353A of the airbag body 347A at the expansion/inflation of the airbag 346A, until the completion of the expansion, though the airbag body 347A is subjected to the resistance due to the slip cloth 353A, as illustrated in FIGS. 30A and 30B. The expansion of the airbag body 347A can smoothly be guided by the rear surface 353g of the slip cloth 353A over the entire region from the left edge 347c to the right edge 347d in the lateral direction, which is connected to the slip cloth 353A.

Incidentally, the knee-protecting airbag devices M2 and M3 according to the sixth embodiment and a seventh embodiment differ from each other only in a place at which each of the slip cloth 353A and the slip cloth 353B is connected to an associated one of the airbag bodies 347A and 347B of the airbags 346A and 346B. The remaining components of each of the sixth and seventh embodiments are similar to the associated ones of the fifth embodiment, and are mounted in a vehicle, similarly to the fifth embodiment. Therefore, the description of such remaining components is omitted.

Additionally, in the fifth embodiment, the knee-protecting airbag device M1 to be attached to the steering column is configured so that when operated, the accommodated airbag 346 is protruded downwardly from the case 332 serving as the accommodation part, and is expanded and inflated in both the lateral directions, and is mounted in a lower part 316a of the column cover 316 covering the steering column 303, which protrudes rearwardly from the instrument panel 307, similarly to the sixth and seventh embodiments. With the configuration of the knee-protecting airbag device M1 to be attached to the steering column, the distance between the case 332 serving as the accommodation part placed in the column cover 316 and each of both the left and right knees KL and KR of the driver D serving as an occupant is short. Thus, there is a high degree of fear that the airbag 46 at the expansion/inflation enters the space between both the left and right knees KL and KR of the driver D. However, according to the fifth embodiment, the airbag body 347 enabled to protect both the left and right knees KL and KR can stably be expanded and inflated to both lateral sides utilizing the slip cloth 353, without being caused to enter the space between both the knees KL and KR, and can appropriately be used.

Further, in the fifth embodiment (similarly to the sixth and seventh embodiments), in the airbag body 347, the inflator 337 for supplying inflation gas G is accommodated. At completion of expansion/inflation, at least parts 359a of the folded parts 359, 359 caused to approach close to the central part in the lateral direction at the sides of both the left and right edges of the airbag body 347, that is, the left edge 347c and the right edge 347d are adjacently provided to be placed side by side in the lateral direction below the inflator 337. That is, as illustrated in FIGS. 26C to 26E, the airbag body 347 is folded by placing the left and right folded parts 359, 359 of the airbag body 347, together with the convolution parts 354 of the slip cloth 353, on the occupant-side wall portion 348. With this configuration, the lateral width dimension BH of the folded airbag 346 and the inflator 337 can be reduced. The airbag device according to the fifth embodiment can be more appropriately used as the knee-protecting airbag device M1 to be attached to the steering column 303, the mounting space of which is limited.

Apparently, the knee-protecting airbag device according to the invention can be mounted in the lower panel 309 of the instrument panel 307 below the column cover 316 or in the part of the instrument panel 307, which is placed in front of an assistant driver's seat.

What is claimed is:

1. A knee-protecting airbag device mounted in a lower portion side of a column cover which covers a steering column and protrudes obliquely upwardly and backwardly from an instrument panel so that a folded airbag is accommodated and mounted in an accommodation part in said lower portion side of said column cover, that when operated, inflation gas is supplied to said airbag which is then protruded obliquely backwardly and downwardly from said accommodation part in said lower portion side of said column cover while expanding and inflating, so as to be disposed to cover a bottom surface of a periphery of said accommodation part of said column cover and a rear surface of said instrument panel, which is placed in a periphery of said column cover, in front of knees of a driver, said knee-protecting airbag device,
wherein a panel surface placed at each of lateral sides of said column cover from below said column cover in said rear surface of said instrument panel covered with said airbag at completion of inflation thereof is provided as a substantially flat surface extending in a lateral direction so that an upper portion thereof protrudes backwardly;
said column cover is provided as a substantially flat surface so that a vicinity of a front end of a projection opening of said airbag at the completion of inflation thereof in said accommodation part is detached backwardly from said panel surface, and that said bottom surface is extended obliquely upwardly and backwardly, as viewed from a side, to approach closer to a horizontal plane from said panel surface so as to intersect with said panel surface at an angle;
an outer peripheral wall of said airbag at completion of inflation thereof includes a driver-side wall portion disposed at a driver side and a column side wall portion configured so that a mounting part thereof to be mounted in said accommodation part is disposed in proximity of a center in anteroposterior and lateral directions, and that the entirety of an outer peripheral edge thereof continues to an outer peripheral edge of said driver-side wall portion;
said column-side wall portion of said airbag is configured to cover, at completion of inflation of said airbag, said bottom surface of said periphery of said accommodation part of said column cover and said panel surface which is placed at each of said lateral sides of said column cover from below said column cover; and
said airbag is configured so that at completion of inflation of said single airbag, an intersection angle between front surfaces of a front-side part and a rear-side part placed in anteroposterior positions in a vicinity of a center in an anteroposterior direction of said column-side wall portion is substantially equal to an intersection angle between said panel surface and a bottom surface of said column cover protruding from said panel surface.

2. The knee-protecting airbag device according to claim 1, wherein said intersection angle between said front surfaces of said front-side part and said rear-side part of said column-side wall portion of said airbag is set by a front tether and a rear tether which are disposed in said airbag and extend from said front-side part and said rear-side part and are connected to said driver-side wall portion to determine a thickness of said airbag at completion of inflation thereof.

3. The knee-protecting airbag device according to claim 2, wherein said airbag is configured to be of a flat airbag type in which said driver-side wall portion and said column-side wall portion have a substantially same outer shape, and that said front tether and said rear tether are provided so that a span between connection parts of said front tether and said rear tether, which are connected to said driver-side wall portion, is set to be shorter than a span between connection parts of said front tether and said rear tether, which are connected to said column-side wall portion.

4. The knee-protecting airbag device according to claim 1, wherein said column cover is configured so that said projection opening, from which said airbag at inflation thereof is protruded, is disposed from a bottom surface of said column cover to both lateral side surfaces thereof so as to extend from below said accommodation part to each of both lateral sides of said accommodation part.

5. An airbag device comprising:
an airbag adapted to expand and inflate while protruding from a mounting part, in which said airbag is folded and accommodated, when inflation gas flows thereinto; and
an inflator attached to said mounting part by placing one end thereof outside said airbag and inserting the other end having a gas discharge port, which is enabled to discharge inflation gas, into said airbag through an insertion hole, an attaching part of said airbag being attached to said mounting part so that a tensile force acts upon a periphery of said insertion hole, whose position is restricted to the other end of said inflator at expansion/inflation of said airbag, said airbag device, wherein said airbag comprises:
an airbag body having said insertion hole, and being configured to inflate when the inflation gas is flowed thereinto, to constitute an outer peripheral wall of said airbag; and
a flexible seal cloth having a fitting hole, into which the other end of said inflator to be inserted into said insertion hole is fittable, and being placed on a periphery of said insertion hole of said airbag body; and
said seal cloth is attached to said periphery of said insertion hole of said airbag body in a state in which a looseness enabling relative displacement movement between a periphery of said fitting hole of said seal cloth and said periphery of said insertion hole is provided at a side in a direction of application of the tensile force in said periphery of said fitting hole and in which the other end of said inflator to be inserted into said insertion hole is fit into said fitting hole.

6. The airbag device according to claim 5, wherein said seal cloth of the airbag is provided on an inner peripheral surface side of said airbag body.

7. The airbag device according to claim 6, wherein only both edges of said seal cloth of said airbag, which are intervened by said fitting hole and extend along a direction of action of the tensile force.

8. A knee-protecting airbag device comprising:
an airbag placed in front of left and right knees of a seated occupant at completion of expansion/inflation by being supplied with inflation gas at completion of inflation by being supplied with inflation gas,
said airbag being folded by bringing both lateral edges thereof at completion of inflation thereof close to a center thereof so as to set a lateral width dimension to be less than a width dimension thereof at the completion of inflation thereof, said airbag being accommodated in a mounting part placed in an area in front of a space between both left and right knees of the occupant, said airbag device,
wherein said airbag comprises:
an airbag body which is inflated like a plate and which has an occupant side wall portion placed at an occupant-side at completion of inflation, and a vehicle-body side wall portion placed at a vehicle-body-side wall portion; and
a slip cloth which has flexibility and is placed at an occupant-side of said airbag body at expansion/inflation;
said slip cloth is configured so that a front surface of said slip cloth is made to abut against said left and right knees of the occupant at an occupant side of said airbag body protruding from said accommodation part so as to close a space between both said knees by said front surface, that said airbag body is slid on a rear surface of said slip cloth so as to be able to guide the expansion of said airbag body in both lateral directions;
said slip close is such that a loosened portion folded only with said slip cloth is provided therein so as to shorten a lateral length thereof, and that said slip cloth is accommodated together with said airbag body in said accommodation part so as to cover at least both lateral side surfaces from an occupant side surface of said folded airbag body; and
a lateral length dimension of said slip cloth expanded flat is set at a dimension enabling said front surface to abut against said left and right knees of the occupant at the occupant side of said airbag body which projects from said accommodation part at expansion/inflation of said airbag, so as to close said space between said left and right knees of the occupant.

9. The knee-protecting airbag device according to claim 8, wherein a convolution part, into which only a part of each of both lateral edge portions of said slip cloth is convolved, is formed in a folding portion folded closer toward a center in a lateral direction of an associated one of both lateral edges of said airbag body in a state in which said occupant-side wall portion of said airbag body is overlapped with both associated lateral edges of said slip cloth, with the occupant-side wall portion of said airbag body only a part of said slip cloth, and that said convolution parts are accommodated in said accommodation part together with airbag body.

10. The knee-protecting airbag device according to claim 9, wherein said slip cloth is provided so that a central part in a lateral direction is connected to a central part in a lateral direction of said occupant-side wall portion of said airbag body.

11. The knee-protecting airbag device according to claim 9, wherein said slip cloth is provided so that at least one of lateral edges of said slip cloth is connected to an associated lateral edge of said airbag body.

12. The knee-protecting airbag device according to claim 8, wherein, by being mounted in a lower portion side of a column cover covering a steering column projected backwardly from an instrument panel so that when operated, said accommodated airbag is protruded downwardly from said accommodation part and is expanded and inflated toward both lateral sides thereof when operated, inflation gas is supplied to said airbag which

13. The knee-protecting airbag device according to claim 12, wherein an inflator for supplying inflation gas is accommodated in said airbag body, and that said airbag is accommodated in said accommodation part by adjacently providing at least apart of said folding portions, which fold said slip cloth close to a center in the lateral direction of both lateral edge sides of said airbag body at the expansion/inflation, side by side below said inflator.
